(19) United States
(12) Patent Application Publication
(10) Pub. No.: US 2023/0397279 A1
(43) Pub. Date: Dec. 7, 2023

(54) APPARATUS, SYSTEM, AND METHOD OF BIDIRECTIONAL BLUETOOTH (BT) STREAM CONNECTION FOR COMMUNICATION OF AUDIO DATA

(71) Applicants: Chethan Tumkur Narayan, Bengaluru (IN); Oren Haggai, Kefar Sava (IL); Arnaud Pierres, Menlo park, CA (US); Balvinder Pal Singh, Bhilai (IN)

(72) Inventors: Chethan Tumkur Narayan, Bengaluru (IN); Oren Haggai, Kefar Sava (IL); Arnaud Pierres, Menlo park, CA (US); Balvinder Pal Singh, Bhilai (IN)

(21) Appl. No.: 18/454,846

(22) Filed: Aug. 24, 2023

(51) Int. Cl. H04W 76/15; H04W 28/02; H04L 5/00

(52) U.S. Cl. CPC H04W 76/15; H04W 28/0226; H04L 5/0048; H04W 88/04

(57) ABSTRACT

For example, a first Bluetooth (BT) device may be configured to set up a bidirectional BT stream connection with a second BT device based on connection configuration information defined according to one or more stream setup messages communicated between the first BT device and the second BT device, wherein the bidirectional BT stream connection is configured to support communication of an audio data stream from the second BT device to the first BT device and a non-audio data stream from the first BT device to the second BT device, wherein the non-audio data stream includes head-orientation data based on an orientation of a head of a user, wherein the connection configuration information includes non-audio data stream configuration information to indicate a configuration of the non-audio data stream; and to transmit the head-orientation data to the second BT device according to the configuration of the non-audio data stream.

### BACKGROUND

A first Bluetooth device may be connected to and/or paired with a second Bluetooth device, for example, to transfer data between the first and second Bluetooth devices.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of communication between an audio source device and an audio sink device according to a Published Audio Capabilities Service (PACS) protocol, in accordance with some demonstrative aspects.

FIG. 3 is a schematic illustration of a communication scheme for communication between a first BT device and a second BT device, in accordance with some demonstrative aspects.

FIG. 4 is a schematic illustration of a communication scheme for communication between a first BT device and a second BT device, in accordance with some demonstrative aspects.

FIG. 5 is a schematic illustration of a communication scheme for communication between a first BT device and a second BT device, in accordance with some demonstrative aspects.

FIG. 6 is a schematic illustration of communication of audio data and non-audio data over a bidirectional BT stream connection between a first BT device and a second BT device, in accordance with some demonstrative aspects.

FIG. 7 is a schematic illustration of audio configuration characteristics, in accordance with some demonstrative aspects.

FIG. 8 is a schematic illustration of audio configuration requirements, in accordance with some demonstrative aspects.

FIG. 9 is a schematic illustration of setting up a bidirectional BT stream connection, in accordance with some demonstrative aspects.

FIG. 10 is a schematic flow-chart illustration of a method of communicating audio data and non-audio data over a bidirectional BT stream connection, in accordance with some demonstrative aspects.

FIG. 11 is a schematic flow-chart illustration of a method of communicating audio data and non-audio data over a bidirectional BT stream connection, in accordance with some demonstrative aspects.

FIG. 12 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Bluetooth (BT) device, a Bluetooth Low Energy (BLE) device, an audio device, a video device, an audio (A/V) device, a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing Bluetooth standards (“the Bluetooth standards”), e.g., including Bluetooth Core Specification (Bluetooth Core Specification V 5.3, Jul. 13, 2021), Audio Stream Control Service (ASCS) Specification (Audio Stream Control Service (ASCS) Specification V 1.0, Sep. 14, 2021), Basic Audio Profile (BAP) Specification (Basic Audio Profile (BAP) Specification V 1.0, Sep. 14, 2021); Published Audio Capabilities Service (PACS) Specification (Published Audio Capabilities Service (PACS) Specification V 1.0, Sep. 14, 2021), and/or future versions and/or derivatives thereof, devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020)) and/or future versions and/or derivatives thereof, devices and/or networks operating in accordance with existing cellular specifications and/or protocols, units and/or devices which are part of the above networks, and the like.

Some aspects may be used in conjunction with one way and/or two-way radio communication systems, a Bluetooth system, a BLE system, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), Extended GPRS, Code-Division Multiple Access (CDMA), Wideband CDMA (WCDMA), CDMA 2000, single-carrier CDMA, multi-carrier CDMA, Multi-Carrier Modulation (MCM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE Advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a frequency band of 2.4 GHz, 5 GHz, or 6 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects are described herein with respect to BT communication, e.g., according to a BT protocol and/or a BLE protocol. However, other aspects may be implemented with respect to any other communication scheme, network, standard and/or protocol.

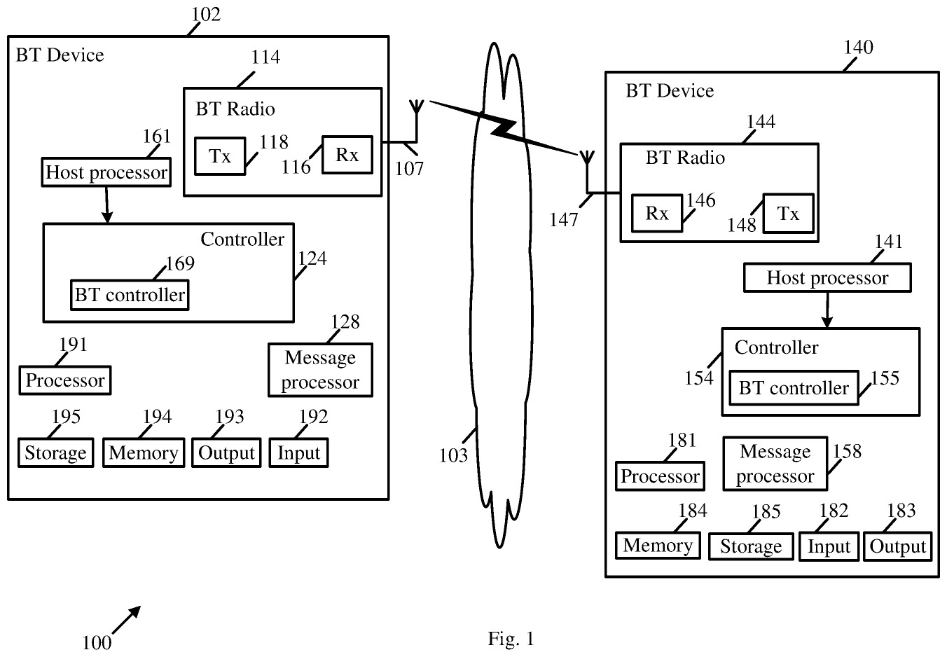

Reference is now made to FIG. 1, which schematically illustrates a block diagram of a system 100, in accordance with some demonstrative aspects.

As shown in FIG. 1, in some demonstrative aspects system 100 may include a wireless communication network including one or more wireless communication devices, e.g., including wireless communication devices 102 and/or 140.

In some demonstrative aspects, devices 102 and/or 140 may include, operate as, and/or perform the functionality of one or more BT devices.

In some demonstrative aspects, devices 102 and/or 140 may include a BT mobile device. In other aspects, devices 102 and/or 140 may include may include a non-mobile BT device.

In one example, devices 102 and/or 140 may include BT Low Energy (LE) (BLE) compatible devices. In other aspects, devices 102 and/or 140 may include or implement any other additional or alternative BT communication functionality, e.g., according to any other additional or alternative BT protocol.

In some demonstrative aspects, device 140 may include, operate as, and/or perform the functionality of, a BT audio device. For example, the BT audio device may include a BT headset, a BT headphone, a BT earphone, a BT hands-free device, a voice-controlled device, a smart speaker device, a sensor device, a BT A/V device, a device incorporating a BT audio device, and/or any other audio device, which may be configured to communicate audio traffic with BT device 102, e.g., as described below.

In some demonstrative aspects, device 140 may include, operate as, and/or perform the functionality of a BT audio sink device. For example, BT audio sink device 140 may include a headset, earphones, a hearing aid, and/or any other device configured to output audio to a user of the BT audio sink device 140.

In some demonstrative aspects, device 102 may include, for example, a UE, an MD, a STA, a PC, a desktop computer, a mobile computer, a laptop computer, an Ultrabook™ computer, a notebook computer, a tablet computer, a server computer, a handheld computer, a Smartphone, a mobile phone, a cellular telephone, a Human Interface Device (HID), a sensor device, a handheld device, a wearable device, an on-board device, an off-board device, a hybrid device, a consumer device, a vehicular device, a non-vehicular device, a mobile or portable device, a non-mobile or non-portable device, a video device, an audio device, an A/V device, a media player, a television, a music player, or the like.

In some demonstrative aspects, device 102 may include, operate as, and/or perform the functionality of a BT audio source device. For example, BT audio source device 102 may be configured as BT audio broadcast device, which may broadcast audio streams via BT communication, e.g., as described below.

In some demonstrative aspects, devices 102 and/or 140 may include, operate as, and/or perform the functionality of one or more STAs. For example, device 102 may include at least one STA, and/or device 140 may include at least one STA.

In some demonstrative aspects, devices 102 and/or 140 may include, operate as, and/or perform the functionality of one or more WLAN STAs.

In some demonstrative aspects, devices 102 and/or 140 may include, operate as, and/or perform the functionality of one or more Wi-Fi STAs.

In one example, a station (STA) may include a logical entity that is a singly addressable instance of a medium access control (MAC) and physical layer (PHY) interface to the wireless medium (WM). The STA may perform any other additional or alternative functionality.

In other aspects, devices 102 and/or 140 may include, operate as, and/or perform the functionality of any other type of STA and/or device. In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of device 102 and/or device 140 may be enclosed in a common housing or packaging, and may be interconnected or operably associated using one or more wired or wireless links. In other aspects, components of device 102 and/or device 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 may execute instructions, for example, of an OS of device 140 and/or of one or more suitable applications.

In some demonstrative aspects, input unit 192 and/or input unit 182 may include, for example, a keyboard, a keypad, a mouse, a touch-screen, a touch-pad, a microphone, or other suitable pointing device or input device. Output unit 193 and/or output unit 183 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103.

In some demonstrative aspects, wireless medium 103 may include, for example, a BT channel, a radio channel, a cellular channel, a Global Navigation Satellite System (GNSS) Channel, an RF channel, a WiFi channel, an IR channel, and the like.

In some demonstrative aspects, wireless communication medium 103 may include a 2.4 GHz frequency band, and/or one or more other wireless communication frequency bands, for example, a 5 GHz frequency band, a 6 GHz frequency band, a millimeterWave (mmWave) frequency band, e.g., a 60 GHz frequency band, a Sub-1 GHz (S1G) band, and/or any other frequency band.

In some demonstrative aspects, devices 102 and/or 140 may include one or more BT radios including circuitry and/or logic to perform wireless communication between devices 102, 140 and/or one or more other BT devices. For example, device 102 may include at least one BT radio 114, and/or device 140 may include at least one BT radio 144.

In some demonstrative aspects, devices 102 and/or 140 may include one or more other radios, e.g., a WiFi radio, an OFDM radio, a cellular radio, and/or the like.

In some demonstrative aspects, BT radio 114 and/or BT radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative aspects, BT radio 114 and/or BT radio 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative aspects, BT radio 114, BT radio 144, transmitter 118, transmitter 148, receiver 116, and/or receiver 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, BT radio 114 and/or BT radio 144 may be configured to communicate over a 2.4 GHz band, and/or any other band.

In some demonstrative aspects, BT radio 114 and/or BT radio 144 may include, or may be associated with, one or more antennas. For example, BT radio 114 may include, or may be associated with, one or more antennas 107; and/or BT radio 144 may include, or may be associated with, one or more antennas 147.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In one example, controller 124 may include circuitry and/or logic, for example, one or more processors including circuitry and/or logic, to cause, trigger and/or control a BT audio device, e.g., device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, controller 124 may be configured to include and/or perform one or more functionalities and/or operations of a BT controller 169 of the BT device 102.

In some demonstrative aspects, one or more functionalities and/or operations of controller 124 may be implemented as part of a host processor 161 of the BT device 102.

In other aspects, controller 124 may be implemented by one or more additional or alternative elements of device 102.

In some demonstrative aspects, controller 154 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of controller 154. Additionally or alternatively, one or more functionalities of controller 154 may be implemented by logic, which may be executed by a machine and/or one or more processors, e.g., as described below.

In one example, controller 154 may include circuitry and/or logic, for example, one or more processors including circuitry and/or logic, to cause, trigger and/or control a BT audio device, e.g., device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, controller 154 may be configured to include and/or perform one or more functionalities and/or operations of a BT controller 155 of the BT device 140.

In some demonstrative aspects, one or more functionalities and/or operations of controller 154 may be implemented as part of a host processor 141 of the BT device 140.

In other aspects, controller 154 may be implemented by one or more additional or alternative elements of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include circuitry and/or logic, e.g., processor circuitry and/or logic, memory circuitry and/or logic, MAC circuitry and/or logic, PHY circuitry and/or logic, and/or any other circuitry and/or logic, configured to perform the functionality of message processors 128 and/or 158. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of BT radio 114. For example, the chip or SoC may include one or more elements of controller 124, one or more elements of message processor 128, and/or one or more elements of BT radio 114. In one example, controller 124, message processor 128, and BT radio 114 may be implemented as part of the chip or SoC.

In other aspects, controller 124, message processor 128 and/or BT radio 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of BT radio 144. For example, the chip or SoC may include one or more elements of controller 154, one or more elements of message processor 158, and/or one or more elements of BT radio 144. In one example, controller 154, message processor 158, and BT radio 144 may be implemented as part of the chip or SoC.

In other aspects, controller 154, message processor 158 and/or BT radio 144 may be implemented by one or more additional or alternative elements of device 140.

In some demonstrative aspects, device 102 and/or device 140 may be configured to implement one or more functionalities and/or operations according to a wireless audio streaming technology, for example, a Bluetooth Low Energy (BLE) Audio technology, e.g., as described below.

In some demonstrative aspects, device 102 and/or device 140 may be configured to implement a spatial audio streaming mechanism configured to provide a technical solution to support communication of human perceivable spatial audio over a bidirectional BT stream connection, e.g., as described below.

In some demonstrative aspects, device 102 and/or device 140 may be configured to implement a spatial audio streaming mechanism, which may be configured to support communication of Bluetooth LE audio, for example, via one or more Bluetooth Low Energy radios technologies and/or protocols, e.g., as described below.

For example, a Bluetooth LE radio protocol may be implemented to deliver a deterministic rate scheduling, which may enable, for example, wireless communication with an inherent lower latency operation.

For example, BLE audio technologies may be implemented to provide a technical solution to support communication of Bluetooth LE Audio, for example, in a manner, which support development of substantially the same audio products and/or use cases, e.g., as classic audio.

For example, BLE audio technologies may be implemented to provide a technical solution to support communication of Bluetooth LE Audio, for example, in a manner, which may introduce new features, e.g., which may improve performance and/or enable the creation of new products and/or audio use cases, for example, such as Unicast (Music/Voice), Auracast/Broadcast, Gaming, Hearing Aid, Spatial audio, and/or any other additional or alternative products and/or product features.

In some demonstrative aspects, device 102 and/or device 140 may be configured to implement a spatial audio streaming mechanism, which may be configured to support communication of spatial audio, for example, in a manner, which may provide a user with an experience of wireless immersive audio, e.g., as described below.

In some demonstrative aspects, device 102 and/or device 140 may be configured to implement a spatial audio streaming mechanism, which may be configured to support dynamic head tracking, e.g., as described below.

In some demonstrative aspects, the spatial audio streaming mechanism may be configured to support implementation of spatial audio with dynamic head tracking, for example, to provide a technical solution to bring theater-like sound, e.g., from a movie and/or video a user is watching, for example, such that a sound may seem to the user as if it is coming from all around the user.

For example, spatial audio with dynamic head-tracking may utilize one or more sensors, for example, an accelerometer and/or a gyroscope, in combination with directional audio filters and/or subtle adjustment of frequencies that each ear receives, for example, to place sounds “virtually anywhere” within a hemisphere of sound. In other aspects, the spatial audio with dynamic head-tracking may utilize any other additional or alternative mechanisms and/or techniques.

For example, an LE Audio protocol may be implemented to utilize a relatively low latency operation of an LE radio, for example, to ensure end to end latency requirements for that head-tracking.

In some demonstrative aspects, device 102 and/or device 140 may be configured to implement a spatial audio streaming mechanism, which may be configured to support communication of non-audio content to support human perceivable spatial audio over a Bluetooth LE audio stream connection, e.g., as described below.

In some demonstrative aspects, the spatial audio streaming mechanism may be configured to support communication of human perceivable spatial audio information and non-audio content over a BT LE audio Connected Isochronous Stream (CIS) connection, for example, using an audio configuration, e.g., as described below.

In some demonstrative aspects, the spatial audio streaming mechanism may be configured to support communication of human perceivable spatial audio information and non-audio content over a bidirectional LE audio CIS connection, e.g., as described below.

In other aspects, the spatial audio streaming mechanism may be configured to support communication of human perceivable spatial audio information and non-audio content over any other additional or alternative type of stream connection.

In some demonstrative aspects, the spatial audio streaming mechanism may be configured to provide a technical solution to support communication of the non-audio content over the BT LE audio stream connection, for example, with a zero retransmission and/or no retransmission policy, e.g., as described below.

In some demonstrative aspects, the spatial audio streaming mechanism may be configured to provide a technical solution to support communication of the non-audio content over the BT LE audio stream connection, for example, with a relatively low latency, e.g., a latency of less than 10 milliseconds (ms) or any other suitable latency, for example, to ensure that there is substantially no lag and/or delay in the audio experience, for example, by minimizing end-to-end latency from head movement to a resulting audio scene move, e.g., as described below.

In some demonstrative aspects, the spatial audio streaming mechanism may be configured to provide a technical solution to support communication of the non-audio content over the BT LE audio stream connection, for example, head-track information may be, e.g., shall be, sent from a headset device to an audio source device, for example, within a human perceivable audio quality spatial differentiation, e.g., based on the distance from the audio source device, e.g., as described below.

In some demonstrative aspects, the spatial audio streaming mechanism may be configured to sub-divide head-movement detections into a plurality of movement categories, for example, in an optimized way, e.g., as described below.

In some demonstrative aspects, plurality of movement categories may include, for example, a first movement category (major category) for detection of movement of the body, and/or a second movement category (minor category) for detection of movement of the head, e.g., as described below. In other aspects, any other additional or alternative movement categories may be implemented.

For example, the major movement category may be defined to include body movements such as, for example, running, bending, exercising, and/or any other additional or alternative body movements.

For example, the minor movement category may include head tracking movements of a user, for example, while the user is seated and/or performs substantially only head movement.

In some demonstrative aspects, the spatial audio streaming mechanism may be configured to provide a technical solution to support communication of the non-audio content, for example, by communicating either major or minor body movements, and/or both major and minor body movements, e.g., batched together, for example, for last N transitions of interest, for example, based on a human perceivable setting time, e.g., as described below.

In some demonstrative aspects, the spatial audio streaming mechanism may be configured to provide a technical solution to support communication of the non-audio content, e.g., including major movement human perceivable spatial audio data and/or minor movement human perceivable spatial audio data, for example, by communication of propriety signals over an LE CIS channel, e.g., as described below.

In some demonstrative aspects, the spatial audio streaming mechanism may be configured to provide a technical solution to support communication of the non-audio content, for example, by communicating major movement human perceivable spatial audio data and/or minor movement human perceivable spatial audio data in a human perceivable spatial audio data chunk, e.g., a chunk of less than 30 bytes or any other chunk size, e.g., as described below.

In some demonstrative aspects, the spatial audio streaming mechanism may be configured to provide a technical solution to support communication of the human perceivable spatial audio data chunk, for example, with a configurable data rate in any predefined format, for example, in a very short burst over an LE CIS connection, e.g., as described below.

In some demonstrative aspects, the spatial audio streaming mechanism may be configured to provide a technical solution to support providing to an individual ear bud/piece its own head-track/position data, e.g., as described below. For example, the ear bud/piece head-track/position data may be clubbed together and sent as a single data Protocol Data Unit (PDU), e.g., as described below.

In some demonstrative aspects, the spatial audio streaming mechanism may be configured to provide a technical solution to support selective enabling and/or disabling of the communication of the non-audio content, e.g., including major movement human perceivable spatial audio data and/or minor movement human perceivable spatial audio data, for example, based on a certain battery discharge threshold/rate of a current battery status/indicator of the audio sink device, e.g., the headphone.

For example, an audio source device, e.g., PC/Phone, may, e.g., shall, decide to enable/disable the head-track data from an audio sink device, e.g., earbuds, and/or may, e.g., shall, choose any one of the earbuds as needed, for example, based on a certain battery discharge threshold/rate of the current battery status/indicator of the audio sink device.

In some demonstrative aspects, controller 154 and/or BT controller 155 may be configured to control, trigger, cause, and/or instruct a first BT device, e.g., BT device 140, to set up a bidirectional BT stream connection with a second BT device, for example, based on connection configuration information defined according to one or more stream setup messages communicated between the first BT device and the second BT device, e.g., as described below.

For example, BT device 140 may be configured to set up a bidirectional BT stream connection with BT device 102, for example, based on connection configuration information defined according to one or more stream setup messages communicated between BT device 140 and BT device 102.

In some demonstrative aspects, the bidirectional BT stream connection may be configured to support communication of an audio data stream from the second BT device to the first BT device, e.g., as described below.

For example, the bidirectional BT stream connection may be configured to support communication of an audio data stream from BT device 102 to BT device 140.

In some demonstrative aspects, the bidirectional BT stream connection may be configured to support communication of a non-audio data stream from the first BT device to the second BT device, e.g., as described below.

For example, the bidirectional BT stream connection may be configured to support communication of a non-audio data stream from BT device 140 to device 102.

In some demonstrative aspects, the non-audio data stream may include head-orientation data, which may be based, for example, on an orientation of a head of a user, e.g., as described below.

In some demonstrative aspects, the connection configuration information for the bidirectional BT stream connection may include non-audio data stream configuration information to indicate a configuration of the non-audio data stream, e.g., as described below.

In some demonstrative aspects, controller 154 and/or BT controller 155 may be configured to control, trigger, cause, and/or instruct BT device 140 to transmit the head-orientation data to the second BT device, for example, according to the configuration of the non-audio data stream, e.g., as described below.

In some demonstrative aspects, the non-audio data stream configuration information may configure the non-audio data stream with a latency of no more than 10 milliseconds, for example, a latency of about 7.5 milliseconds, and/or any other latency.

In some demonstrative aspects, the non-audio data stream configuration information may configure the non-audio data stream, for example, according to a zero retransmission policy, which may define, for example, no retransmission of the head-orientation data, e.g., as described below.

In some demonstrative aspects, the head-orientation data may include angle of rotation information representing an angle of rotation of the head of the user, e.g., as described below.

In some demonstrative aspects, the head-orientation data may include acceleration information representing an acceleration of the head of the user, e.g., as described below.

In other aspects, the head-orientation data may include information representing any other type of movement of the head of the user.

In some demonstrative aspects, the head-orientation data may include angle of rotation information representing an angle of rotation of the head of the user in a quaternion format, e.g., as described below.

In other aspects, the head-orientation data may include angle of rotation information representing an angle of rotation of the head of the user in any other additional or alternative format.

In some demonstrative aspects, the head-orientation data may include body-based movement data, which may be based on a body movement of the user, e.g., as described below.

In some demonstrative aspects, the head-orientation data may include head-based movement data, which may be based on a head movement of the user, e.g., as described below.

In some demonstrative aspects, the head-orientation data may be based on orientation information from a headphone device to provide audio to the user, for example, based on the audio data stream, e.g., as described below.

In some demonstrative aspects, the head-orientation data may be based on orientation information from at least one ear piece to provide audio to the user, for example, based on the audio data stream, e.g., as described below.

In other aspects, the head-orientation data may include any other additional or alternative information, e.g., in any other additional or alternative format, based on the orientation of the head of the user.

In some demonstrative aspects, the audio data stream, e.g., to be communicated over the bidirectional BT stream connection, may include two audio channels, which include spatial audio data to be provided to a headphone device, e.g., as described below.

In some demonstrative aspects, the headphone may include any suitable apparatus including one or more acoustic transducers, e.g., speakers, which may be placed and/or worn on, around, near, and/or over a user's head and/or ear.

In one example, a headphone may be configured to be worn on the head of the user, for example, such that the acoustic transducers are maintained near the ear of the user.

In one example, a headphone may be implemented in the form of a circumaural headphone (also referred to as “full size headphone”, or “over-ear headphone”), which may include pads that surround the outer ear.

In one example, a headphone may be implemented in the form of a supra-aural (on-ear) headphone, which may include a pad that presses against the ear.

In one example, a headphone may be implemented in the form of an ear-fitting headphone, to be worn on an ear of the user.

In one example, a headphone may be implemented in the form of an earphone, which may be placed in or on the outer ear.

In some demonstrative aspects, controller 154 and/or BT controller 155 may be configured to control, trigger, cause, and/or instruct BT device 140 to setup a sink Audio Stream Endpoint (ASE) at the first BT device, for example, to receive the audio data stream from the second BT device, e.g., as described below.

For example, controller 154 and/or BT controller 155 may be configured to control, trigger, cause, and/or instruct BT device 140 to operate as, and/or perform the functionality of, a sink ASE to receive the audio data stream from BT device 102.

In some demonstrative aspects, controller 154 and/or BT controller 155 may be configured to control, trigger, cause, and/or instruct BT device 140 to setup a source ASE at the first BT device, for example, to transmit the non-audio data stream to the second BT device, e.g., as described below.

For example, controller 154 and/or BT controller 155 may be configured to control, trigger, cause, and/or instruct BT device 140 to operate as, and/or perform the functionality of, a source ASE to transmit the non-audio data stream to BT device 102.

In some demonstrative aspects, controller 154 and/or BT controller 155 may be configured to control, trigger, cause, and/or instruct BT device 140 to setup the bidirectional BT stream connection as a bidirectional Low Energy (LE) Connected Isochronous Stream (CIS) connection, e.g., as described below.

In other aspects, any other type of bidirectional BT stream connection may be implemented.

In some demonstrative aspects, controller 154 and/or BT controller 155 may be configured to control, trigger, cause, and/or instruct BT device 140 to set source capability information in a stream setup message to be transmitted from the first BT device to the second BT device, e.g., as described below.

In some demonstrative aspects, the source capability information may include one or more source supported characteristics, which may be supported by BT device 140 for the non-audio data stream, e.g., as described below.

For example, BT device 140 may transmit to BT device 102 a stream setup message including source capability information to indicate one or more source supported characteristics, which may be supported by BT device 140 for the non-audio data stream, e.g., as described below.

In some demonstrative aspects, the one or more source supported characteristics may include a source supported interval between data frames of the non-audio data stream, e.g., as described below.

In some demonstrative aspects, the one or more source supported characteristics may include a source supported report length of a data frame of the non-audio data stream, e.g., as described below.

In some demonstrative aspects, the one or more source supported characteristics may include a source supported coordinate system for the head-orientation data, e.g., as described below.

In other aspects, the source capability information may include any other additional or alternative information to indicate one or more additional or alternative source supported characteristics of the BT device 140.

In some demonstrative aspects, controller 154 and/or BT controller 155 may be configured to control, trigger, cause, and/or instruct BT device 140 to set a metadata parameter to represent the source capability information, e.g., as described below.

In some demonstrative aspects, the stream setup message may include a source Published Audio Capabilities (PAC) record message including a source PAC characteristics element, which may include, for example, the metadata parameter, e.g., as described below.

In some demonstrative aspects, controller 154 and/or BT controller 155 may be configured to control, trigger, cause, and/or instruct BT device 140 to process a stream setup enable message from the second BT device, for example, to identify the non-audio data stream configuration information to indicate the configuration of the non-audio data stream, e.g., as described below.

For example, BT device 140 may receive from BT device 102 a stream setup enable message, which includes the non-audio data stream configuration information to indicate the configuration of the non-audio data stream.

In some demonstrative aspects, the non-audio data stream configuration information may include an enabled interval between data frames of the non-audio data stream, e.g., as described below.

In some demonstrative aspects, the non-audio data stream configuration information may include an enabled length of a data frame of the non-audio data stream, e.g., as described below.

In some demonstrative aspects, the non-audio data stream configuration information may include an enabled coordinate system for the head-orientation data, e.g., as described below.

In other aspects, the non-audio data stream configuration information may include any other additional or alternative information to indicate the configuration of the non-audio data stream.

In some demonstrative aspects, controller 154 and/or BT controller 155 may be configured to control, trigger, cause, and/or instruct BT device 140 to process an ASE enable message from the second BT device, for example, to identify the non-audio data stream configuration information, for example, in a metadata parameter in an additional ASE parameter field of the ASE enable message, e.g., as described below.

In some demonstrative aspects, controller 154 and/or BT controller 155 may be configured to control, trigger, cause, and/or instruct BT device 140 to process an additional ASE parameter field in an ASE codec message from the second BT device, for example, to identify an ASE Identifier (ID) for the non-audio data stream, e.g., as described below.

In some demonstrative aspects, controller 154 and/or BT controller 155 may be configured to control, trigger, cause, and/or instruct BT device 140 to process the additional ASE parameter field in the ASE codec message from the second BT device, for example, to identify a codec specific configuration length field, for example, to indicate a frame length for the non-audio data stream, e.g., as described below.

In some demonstrative aspects, controller 154 and/or BT controller 155 may be configured to control, trigger, cause, and/or instruct BT device 140 to process the additional ASE parameter field in the ASE codec message from the second BT device, for example, to identify a codec specific configuration field in the ASE codec message from the second BT device, for example, to indicate a frame duration for the non-audio data stream, a number of octets per frame for the non-audio data stream, and/or a maximal supported frame length per Protocol Data Unit (PDU) for the non-audio data stream, e.g., as described below.

In some demonstrative aspects, controller 154 and/or BT controller 155 may be configured to control, trigger, cause, and/or instruct BT device 140 to process an additional ASE parameter field in an ASE Quality of Service (QoS) message from the second BT device, for example, to identify an ASE ID for the non-audio data stream, e.g., as described below.

In some demonstrative aspects, controller 154 and/or BT controller 155 may be configured to control, trigger, cause, and/or instruct BT device 140 to process the additional ASE parameter field in the ASE QoS message from the second BT device, for example, to identify a maximal Stream Data Unit (SDU) field, for example, to indicate an SDU length for the non-audio data stream, e.g., as described below.

In some demonstrative aspects, controller 154 and/or BT controller 155 may be configured to control, trigger, cause, and/or instruct BT device 140 to process the additional ASE parameter field in the ASE QoS message from the second BT device, for example, to identify a retransmission number field, for example, to indicate a zero retransmission policy for the non-audio data stream, e.g., as described below.

In some demonstrative aspects, controller 154 and/or BT controller 155 may be configured to control, trigger, cause, and/or instruct BT device 140 to process the additional ASE parameter field in the ASE QoS message from the second BT device, for example, to identify a maximal transport latency field, for example, to indicate a maximal latency for the non-audio data stream, e.g., as described below.

In some demonstrative aspects, controller 154 and/or BT controller 155 may be configured to control, trigger, cause, and/or instruct BT device 140 to transmit the head-orientation data in Stream Data Units (SDUs), which may be configured, for example, according to the non-audio data stream configuration information, e.g., as described below.

In some demonstrative aspects, an SDU size of an SDU may be no more than 14 bytes, e.g., as described below.

In other aspects, any other SDU size may be implemented.

In some demonstrative aspects, controller 154 and/or BT controller 155 may be configured to control, trigger, cause, and/or instruct BT device 140 to initiate communication over the bidirectional BT stream connection, for example, based on an ASE receiver start message from the second BT device, e.g., as described below.

In some demonstrative aspects, an additional ASE parameter field of the ASE receiver start message may include a first ASE ID to identify an ASE for the audio data stream, and a second ASE ID to identify an ASE for the non-audio data stream, e.g., as described below.

In some demonstrative aspects, controller 124 and/or BT controller 169 may be configured to control, trigger, cause, and/or instruct a first BT device, e.g., BT device 102, to set up a bidirectional BT stream connection with a second BT device, for example, based on connection configuration information defined according to one or more stream setup messages communicated between the first BT device and the second BT device, e.g., as described below.

For example, BT device 102 may set up a bidirectional BT stream connection with BT device 140, for example, based on connection configuration information defined according to one or more stream setup messages communicated between BT device 102 and BT device 140.

In some demonstrative aspects, the bidirectional BT stream connection may be configured to support communication of an audio data stream from BT device 102 to BT device 140, e.g., as described below.

In some demonstrative aspects, the bidirectional BT stream connection may be configured to support communication of a non-audio data stream from BT device 140 to BT device 102, e.g., as described below.

In some demonstrative aspects, the non-audio data stream may include head-orientation data, which may be based, for example, on an orientation of a head of a user, e.g., as described below.

In some demonstrative aspects, the connection configuration information for the bidirectional BT stream connection may include non-audio data stream configuration information to indicate a configuration of the non-audio data stream, e.g., as described below.

In some demonstrative aspects, controller 124 and/or BT controller 169 may be configured to control, trigger, cause, and/or instruct BT device 102 to receive the head-orientation data from the second BT device, for example, according to the configuration of the non-audio data stream, e.g., as described below.

In some demonstrative aspects, the received head-orientation data may include the head-orientation data transmitted by the second BT device, e.g., BT device 140.

In some demonstrative aspects, controller 124 and/or BT controller 169 may be configured to control, trigger, cause, and/or instruct BT device 102 to transmit the audio data stream to the second BT device, e.g., as described below.

In some demonstrative aspects, the audio data stream may include spatial audio data, for example, based on the head-orientation data from the second BT device, e.g., as described below.

In some demonstrative aspects, the audio data stream may include two audio channels, for example, to include spatial audio data to be provided to a headphone device, e.g., as described below.

For example, BT device 102 may transmit to BT device 140 the audio data stream, which includes spatial audio data, for example, based on the head-orientation data from device 140.

In some demonstrative aspects, controller 124 and/or BT controller 169 may be configured to control, trigger, cause, and/or instruct BT device 102 to setup the bidirectional BT stream connection as a bidirectional LE CIS connection, e.g., as described below.

In other aspects, any other type of bidirectional BT stream connection may be implemented.

In some demonstrative aspects, controller 124 and/or BT controller 169 may be configured to control, trigger, cause, and/or instruct BT device 102 to process source capability information in a stream setup message from the second BT device, e.g., as described below.

In some demonstrative aspects, the source capability information may include one or more source supported characteristics, which are supported by the second BT device for the non-audio data stream, e.g., as described below.

In some demonstrative aspects, the one or more source supported characteristics may include a source supported interval between data frames of the non-audio data stream, e.g., as described below.

In some demonstrative aspects, the one or more source supported characteristics may include a source supported report length of a data frame of the non-audio data stream, e.g., as described below.

In some demonstrative aspects, the one or more source supported characteristics may include a source supported coordinate system for the head-orientation data, e.g., as described below.

In other aspects, the source capability information may include any other additional or alternative information to indicate one or more additional or alternative source supported characteristics of the BT device 140.

In some demonstrative aspects, the stream setup message may include a source PAC record message including a source PAC characteristics element, which may include, for example, a metadata parameter to represent the source capability information, e.g., as described below.

In some demonstrative aspects, controller 124 and/or BT controller 169 may be configured to control, trigger, cause, and/or instruct BT device 102 to transmit a stream setup enable message to the second BT, for example, BT device 140, e.g., as described below.

In some demonstrative aspects, the stream setup enable message may include the non-audio data stream configuration information to indicate the configuration of the non-audio data stream, e.g., as described below.

In some demonstrative aspects, the non-audio data stream configuration information may include an enabled interval between data frames of the non-audio data stream, e.g., as described below.

In some demonstrative aspects, the non-audio data stream configuration information may include an enabled length of a data frame of the non-audio data stream, e.g., as described below.

In some demonstrative aspects, the non-audio data stream configuration information may include an enabled coordinate system for the head-orientation data, e.g., as described below.

In other aspects, the non-audio data stream configuration information may include any other additional or alternative information to indicate the configuration of the non-audio data stream.

In some demonstrative aspects, controller 124 and/or BT controller 169 may be configured to control, trigger, cause, and/or instruct BT device 102 to transmit an ASE enable message to the second BT device, for example, to BT device 140, e.g., as described below.

In some demonstrative aspects, the ASE enable message may include the non-audio data stream configuration information in a metadata parameter in an additional ASE parameter field of the ASE enable message, e.g., as described below.

In some demonstrative aspects, controller 124 and/or BT controller 169 may be configured to control, trigger, cause, and/or instruct BT device 102 to set an additional ASE parameter field in an ASE codec message to the second BT device, e.g., as described below.

In some demonstrative aspects, the additional ASE parameter field may include an ASE ID for the non-audio data stream, a codec specific configuration length field to indicate a frame length for the non-audio data stream, and/or a codec specific configuration field to indicate a frame duration for the non-audio data stream, a number of octets per frame for the non-audio data stream, and/or a maximal supported frame length per PDU for the non-audio data stream, e.g., as described below.

In some demonstrative aspects, controller 124 and/or BT controller 169 may be configured to control, trigger, cause, and/or instruct BT device 102 to set the codec specific configuration field to set the frame duration for the non-audio data stream to 1 milliseconds, e.g., as described below.

In other aspects, the frame duration for the non-audio data stream may be set to any other duration.

In some demonstrative aspects, controller 124 and/or BT controller 169 may be configured to control, trigger, cause, and/or instruct BT device 102 to set the number of octets per frame for the non-audio data stream to 14 octets, e.g., as described below.

In other aspects, the number of octets per frame for the non-audio data stream may include any other additional or alternative number of octets.

In some demonstrative aspects, controller 124 and/or BT controller 169 may be configured to control, trigger, cause, and/or instruct BT device 102 to set an additional ASE parameter field in an ASE QoS message to the second BT device, e.g., as described below.

In some demonstrative aspects, the additional ASE parameter field may include an ASE ID for the non-audio data stream, as described below.

In some demonstrative aspects, the additional ASE parameter field may include a maximal SDU field, for example, to indicate an SDU length for the non-audio data stream, as described below.

In some demonstrative aspects, the additional ASE parameter field may include a retransmission number field, for example, to indicate a zero retransmission policy for the non-audio data stream, as described below.

In some demonstrative aspects, the additional ASE parameter field may include a maximal transport latency field, for example, to indicate a maximal latency for the non-audio data stream, e.g., as described below.

In other aspects, the additional ASE parameter field may include any other additional or alternative information.

In some demonstrative aspects, controller 124 and/or BT controller 169 may be configured to control, trigger, cause, and/or instruct BT device 102 to set the maximal SDU field to indicate a length of 14 bytes, e.g., as described below.

In other aspects, any other maximal SDU field size may be implemented.

In some demonstrative aspects, controller 124 and/or BT controller 169 may be configured to control, trigger, cause, and/or instruct BT device 102 to set the maximal transport latency field, for example, to indicate a maximal latency of 10 milliseconds, e.g., as described below.

In other aspects, the maximal transport latency field may indicate any other maximal latency value.

In some demonstrative aspects, controller 124 and/or BT controller 169 may be configured to control, trigger, cause, and/or instruct BT device 102 to process the head-orientation data received from the second BT device in SDUs configured, for example, according to the non-audio data stream configuration information, e.g., as described below.

In some demonstrative aspects, an SDU size of an SDU may be no more than 14 bytes.

In other aspects, any other SDU size may be implemented.

In some demonstrative aspects, controller 124 and/or BT controller 169 may be configured to control, trigger, cause, and/or instruct BT device 102 to transmit an ASE receiver start message to the second BT device to initiate communication over the bidirectional BT stream connection, e.g., as described below.

In some demonstrative aspects, an additional ASE parameter field of the ASE receiver start message may include a first ASE ID to identify an ASE for the audio data stream, and a second ASE ID to identify an ASE for the non-audio data stream, e.g., as described below.

In some demonstrative aspects, device 102 and/or device 140 may be configured to implement one or more operations according to a spatial audio streaming mechanism, e.g., as described below.

In some demonstrative aspects, device 102 and/or device 140 may be configured to implement the spatial audio streaming mechanism configured to support communication of a spatial audio over an LE CIS connection, for example, in accordance with a PAC protocol, e.g., as described below.

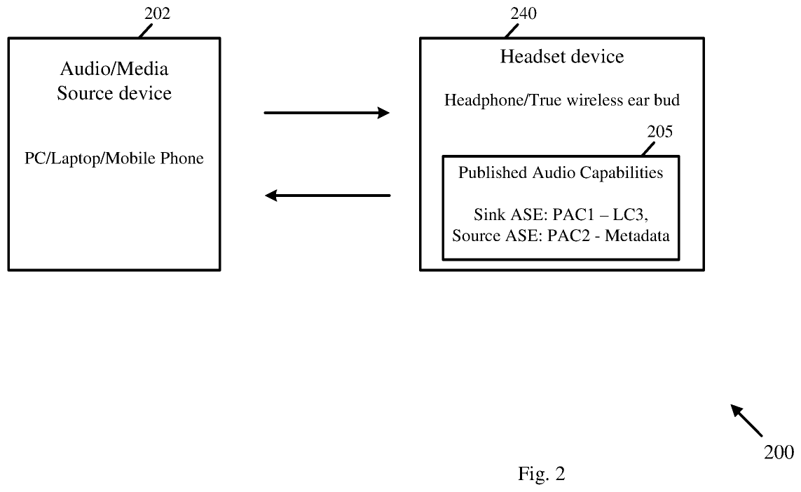

Reference is made to FIG. 2, which schematically illustrates a communication scheme 200 for communication between an audio source device 202, e.g., Phone, a PC or a Laptop device, and an audio sink device, e.g., a headset device 240, according to a PACS protocol, in accordance with some demonstrative aspects.

In one example, BT device 102 (FIG. 1) may operate as, and/or perform one or more operations and/or functionalities of, audio source device 202. In one example, BT device 140 (FIG. 1) may operate as, and/or perform one or more operations and/or functionalities of, headset device 240.

In some demonstrative aspects, headset device 240 may, e.g., shall, support communicating one or more specific capabilities and/or configurations, e.g., of information to be provided from the device's head sensor that capture the head movement, for example, as part of the PACS protocol, e.g., as described below.

In some demonstrative aspects, as shown in FIG. 2, headset device 240 may setup a source Audio Stream Endpoint (ASE) on headset device 240, for example, to transmit a non-audio data stream to audio source device 202, for example, according to the PACS protocol.

In some demonstrative aspects, as shown in FIG. 2, headset device 240 may setup a sink ASE on headset device 240, for example, to receive an audio data stream from audio source device 202, for example, according to the PACS protocol.

For example, as shown in FIG. 2, headset device 240 may receive the audio data stream, which may be encoded, for example, using a Low Complexity Communication Codec (LC3 codec).

In some demonstrative aspects, as shown in FIG. 2, headset device 240 may operate as a sink ASE to receive the audio data stream from audio source device 202 over an LE CIS connection, which may be configured based on an exchange of messages between the audio source device 202 and the headset device 240, e.g., according to the PACS protocol.

In some demonstrative aspects, as shown in FIG. 2, headset device 240 may operate as a source ASE to provide the non-audio content data to audio source device 202, for example, over the LE CIS connection.

In some demonstrative aspects, as shown in FIG. 2, headset device 240 may transmit a source PAC record message 205 to audio source device 202, for example, to publish the audio capabilities of the headset device 240.

In some demonstrative aspects, as shown in FIG. 2, source PAC record message 205 may include a metadata parameter, which may be configured to provide information about the capabilities of the headset device 240 to support human perceivable spatial audio, e.g., based on communication of non-audio content data to be transmitted by the source ASE on the headset device 240.

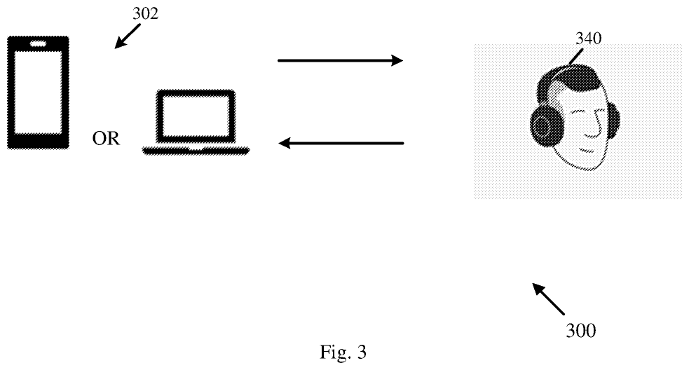

Reference is made to FIG. 3, which schematically illustrates a communication scheme 300 for communication between a first BT device, e.g., a Unicast Client device 302, and a second BT device, e.g., a Unicast Server device 340, in accordance with some demonstrative aspects.

In one example, audio source device 202 (FIG. 2) may operate as, and/or perform one or more operations and/or functionalities of, Unicast Client device 302. In one example, headset device 240 (FIG. 2) may operate as, and/or perform one or more operations and/or functionalities of, Unicast Server device 340.

In some demonstrative aspects, as shown in FIG. 3, Unicast Server device 340, e.g., a headset, a true wireless headset, an earpiece, and/or any other device, may, e.g., shall, transfer non-audio content, e.g., head rotation data, to support human perceivable spatial audio over an LE audio stream connection between Unicast Server device 340 and Unicast Client device 302, e.g., as described below.

In some demonstrative aspects, Unicast Server device 340 may transmit the non-audio content to Unicast client device 302, for example, in accordance with the PACS protocol, e.g., as described above.

In some demonstrative aspects, Unicast Server device 340 may transmit the non-audio content to Unicast client device 302, for example, over an LE CIS transport connection, e.g., as described above.

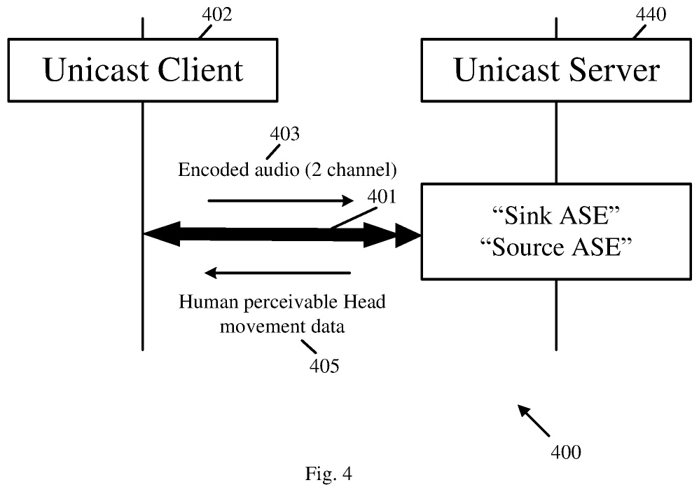

Reference is made to FIG. 4, which schematically illustrates a communication scheme 400 for communication between a first BT device, e.g., Unicast Client device 402, and a second BT device, e.g., Unicast Server device 440, in accordance with some demonstrative aspects.

In one example, BT device 102 (FIG. 1) may operate as, and/or perform one or more operations and/or functionalities of, Unicast Client device 402. In one example, BT device 140 (FIG. 1) may operate as, and/or perform one or more operations and/or functionalities of, Unicast Server device 440.

In some demonstrative aspects, communication scheme 400 may illustrate a possible high-level procedure, for example, for a unicast scenario, utilizing a bi-directional LE CIS connection 401, for example, to support spatial audio data streaming, e.g., as described below.

In some demonstrative aspects, as shown in FIG. 4, bi-directional LE CIS connection 401 may be configured to support communication of an audio data stream 403 from Unicast Client device 402 to Unicast Server device 440.

In some demonstrative aspects, as shown in FIG. 4, bi-directional LE CIS connection 401 may be configured to support communication of a non-audio data stream 405 from Unicast Server device 440 to Unicast Client device 402.

In some demonstrative aspects, as shown in FIG. 4, audio data stream 403 may include, for example, two channels for communication of audio data, e.g., an audio playback, including a first channel of audio data for a first ear and a second channel of audio data for a second ear.

In some demonstrative aspects, as shown in FIG. 4, Unicast Server device 440 may operate as a sink ASE to receive the audio data stream 403 from Unicast Client device 402.

For example, Unicast Server device 440 may include a headset device. According to this example, audio data stream 403 may include a first channel for communication of the audio data to a left earpiece of Unicast Server device 440, and a second channel for communication of the audio data to a right earpiece of Unicast Server device 440.

In some demonstrative aspects, as shown in FIG. 4, Unicast Server device 440 may operate as a source ASE to transmit the non-audio data stream 405 to Unicast Client device 402.

In some demonstrative aspects, as shown in FIG. 4, non-audio data stream 405 may include a channel for communication of non-audio data, e.g., including a head rotation data capture (also referred to as “human perceivable head movement data”), from Unicast Server device 440 to Unicast Client device 402. For example, Unicast Server device 440 may include a headphone including a pair of earbuds, a head phone device.

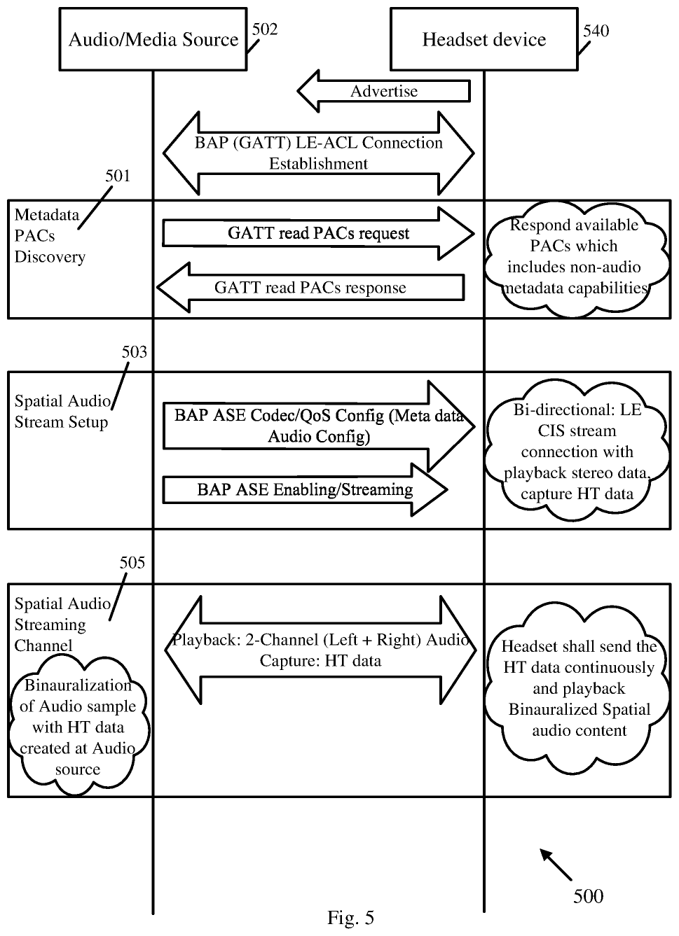

Reference is made to FIG. 5, which schematically illustrates a communication scheme 500 for communication between a first BT device, e.g., an audio/media source 502, and a second BT device, e.g., a headset device 540, in accordance with some demonstrative aspects.

In one example, BT device 102 (FIG. 1) may operate as, and/or perform one or more operations and/or functionalities of, audio/media device 502. In one example, BT device 140 (FIG. 1) may operate as, and/or perform one or more operations and/or functionalities of, headset device 540.

In some demonstrative aspects, audio/media device 502 and/or headset device 540 may be configured to implement one or more operations of communication scheme 500, for example, in accordance with an LE audio profile and/or one or more LE audio protocol procedures, e.g., as described below.

In some demonstrative aspects, as shown in FIG. 5, audio/media device 502 and/or headset device 540 may perform operations of a metadata PACS discovery procedure 501, e.g., in accordance with a PACS protocol.

In some demonstrative aspects, as shown in FIG. 5, audio/media device 502 and/or headset device 540 may perform a spatial audio stream setup procedure 503, e.g., in accordance with the PACS protocol.

In some demonstrative aspects, as shown in FIG. 5, audio/media device 502 and/or headset device 540 may set up a bidirectional BT stream connection based on connection configuration information defined, for example, according to one or more stream setup messages communicated between audio/media device 502 and headset device 540 as part of spatial audio stream setup procedure 503, e.g., as described below.

In some demonstrative aspects, as shown in FIG. 5, audio/media device 502 and/or headset device 540 may perform one or more operations of a spatial audio streaming procedure 505, e.g., as described below.

In some demonstrative aspects, as shown in FIG. 5, the spatial audio streaming procedure 505 may include communication of a non-audio data stream from headset device 540 to audio/media device 502, for example, over the bidirectional BT stream connection.

In some demonstrative aspects, as shown in FIG. 5, the spatial audio streaming procedure 505 may include communication of an audio data stream from audio/media device 502 to headset device 540, for example, based on head-orientation data in the non-audio data stream from headset device 540.

Referring back to FIG. 1, in some demonstrative aspects, device 102 and/or device 140 may be configured to perform one or more operations and/or functionalities of a spatial audio streaming mechanism, which may be configured to provide a technical solution to support a sub-dividing of detected body movements into a plurality of movement categories, e.g., as described below.

In some demonstrative aspects, the detected body movements, e.g., human perceivable movements, may be sub-divided into major body movements, and minor body movements, e.g., as described below. In other aspects, any other additional or alternative movement categories may be implemented.

In some demonstrative aspects, the major body movements may include body-based movements, which may be based on a body movement of a user, e.g., running, bending, exercising, and/or any other additional or alternative type of body-based movements.

In some demonstrative aspects, the minor body movements may include head-based movements, for example, movements, which may be based on a head movement of the user.

In one example, the detected body movements may be categorized into the movement categories, which may result in one or more actions to configure a spatial audio stream by the audio source, e.g., as follows:

TABLE 1

| Major | Minor | Action |
|---|---|---|
| Moving away from the | Distance and head | Faded audio on the |
| audio source faster | movement | headset |
| than normal | | |
| Bending, Exercising | Head movement 90 | Adjust the left/right |
| | degree+, Body angular | accordingly |
| | movement 90 degree+ | |
| Talking to some else | Head movement | Fade the incoming |
| nearby physically | | audio/music |
| | | streaming content |

In other aspects, any other additional and/or alternative movement categories and/or actions for spatial stream audio may be defined.

In some demonstrative aspects, device 140, e.g., a headset device, may, e.g., shall, detect human perceivable movements of the user of the headset device, and may sub-divide them into major and/or minor body movements, e.g., according to the example in Table 1.

In some demonstrative aspects, device 102 and/or device 140 may communicate head-orientation data, for example, based on the detected body movements.

In some demonstrative aspects, device 140 may form a predefined data format to communicate the head-orientation data representing the human perceivable movements, e.g., for each of major body movements, minor body movements, and/or batched movements, for example, representing a transition from a base/start settlement position.

In some demonstrative aspects, device 140 may transmit the head-orientation data to an audio source device, e.g., implemented by device 102 (e.g., PC/Phone/Laptop), for example, over an LE CIS connection.

In some demonstrative aspects, the head-orientation data may include, for example, angle of rotation information representing an angle of rotation of the head of the user, acceleration information representing an acceleration of the head of the user, and/or any other suitable information based on the human perceivable movements of the user of the headset device.

In some demonstrative aspects, the head-rotation data may be represented in a format configured for a data length of up to 14 bytes, e.g., as follows:

TABLE 2

| Byte# | Name | Function |
|---|---|---|
| 0, 1 | W | Angle of rotation w.r.t axis. This is a quaternion |
| 2, 3 | X | defining the orientation of the listener |
| 4, 5 | Y | |
| 6, 7 | Z | |
| 8, 9 | Acc-X | This is a vector representing the acceleration relative |
| 10, 11 | Acc-Y | to the user coordinate |
| 12, 13 | Acc-Z | |

For example, according to lines one to four of Table 2, the angle of rotation of the head of the user may be represented in a quaternion format.

For example, according to lines five to seven of Table 2, an acceleration of the head of the user may be represented by a three-dimensional vector.

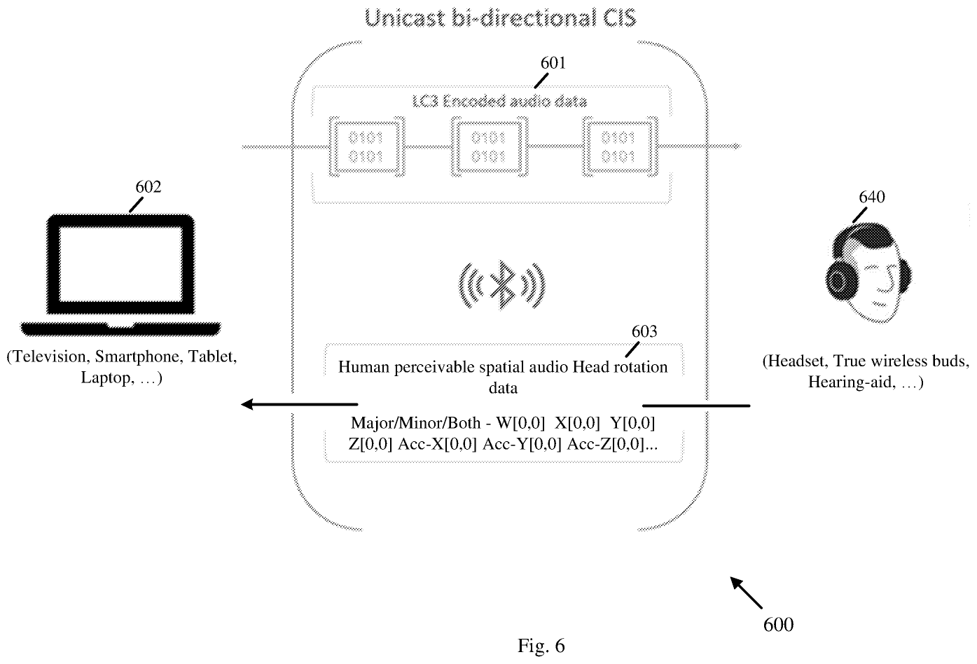

Reference is made to FIG. 6, which schematically illustrates communication of audio data and non-audio data between a first BT device, e.g., an audio source device 602, and a second BT device, e.g., a headset device 640, in accordance with some demonstrative aspects.

In one example, BT device 102 (FIG. 1) may operate as, and/or perform one or more operations and/or functionalities of, audio source device 602. In one example, BT device 140 (FIG. 1) may operate as, and/or perform one or more operations and/or functionalities of, headset device 640.

In some demonstrative aspects, as shown in FIG. 6, headset device 640 may transmit to audio source device 602 a non-audio data stream 603, which includes head-orientation data, for example, based on an orientation of a head of a user of the headset device 640.

In some demonstrative aspects, audio source device 602 may receive the non-audio data stream 603 including the head-orientation data from headset device 640, for example, according to a configuration of the non-audio data stream 603.

In some demonstrative aspects, as shown in FIG. 6, the non-audio data stream 603 may be configured according to one or more a head-rotation data format supported by the headset device 640, e.g., according to one or more of the parameters defined in Table 2.

For example, audio source device 602 may, e.g., shall, process the received head-orientation data, e.g., representing the human perceivable movements, for example, according to a sub-division of the human perceivable movements to major body movements and/or minor body movements.

For example, audio source device 602 may predict transitions for the major body movements, for example, based on the last N batched reports from headset device 640.

For example, audio source device 602 may modify the audio data stream 601, for example, based on the received head-orientation data, e.g., by performing one or more of the actions in Table 1.

In some demonstrative aspects, as shown in FIG. 6, audio source device 602 may transmit to headset device 640 an audio data stream 601, e.g., a modified audio content, which may be, e.g., shall be, encoded, for example, using an LC3 codec, or any other suitable codec.

In some demonstrative aspects, as shown in FIG. 6, audio source device 602 may stream the modified audio content to headset device 640, for example, to provide better spatial audio experience to the user of headset 640.

Referring back to FIG. 1, in some demonstrative aspects, device 102 and/or device 140 may perform one or more operations and/or functionalities of a spatial audio streaming mechanism, which may be configured to support establishment of a BT LE audio connection, for example, according to the PACS protocol, e.g., as described below.

In some demonstrative aspects, device 102 may perform a role of a Unicast Client, which may operate as, and/or perform one or more operations and/or functionalities of, both an audio source on a first stream and an audio sink on a second stream of a bidirectional BT stream connection, e.g., as described below.

In some demonstrative aspects, device 140 may perform a role of a Unicast Server, which may operate as, and/or perform one or more operations and/or functionalities of, both an audio sink on the second stream and an audio source on the first stream of the bidirectional BT stream connection, e.g., as described below.

For example, a Unicast Client, e.g., implemented by device 102, may operate in both the Audio Source and Audio Sink roles, for example, to transmit two channels of audio data, e.g., including left and right (L+R) audio data, to a Unicast Server, e.g., implemented by device 140, and to receive non-audio data, e.g., including head position and/or rotation data, from the Unicast Server, for example, using a bidirectional CIS connection.

For example, the Unicast Server, e.g., implemented by device 140, may operate in both the Audio Sink and Audio Source roles, for example, to receive the two channels of audio data, e.g., including the L+R audio data, from the Unicast Server, e.g., implemented by device 102, and to transmit the non-audio data, e.g., including the head position and/or rotation data, to the Unicast Client, for example, using the bidirectional CIS connection.

For example, device 102 and/or device 140 may communicate the audio data and the non-audio data, for example, using a setting of Audio configuration 5 characteristics, e.g., according to a “Multiple Audio Channels. One bidirectional CIS. Unicast Server is Audio Sink and Audio Source” setting, e.g., in accordance with a BAP Specification.

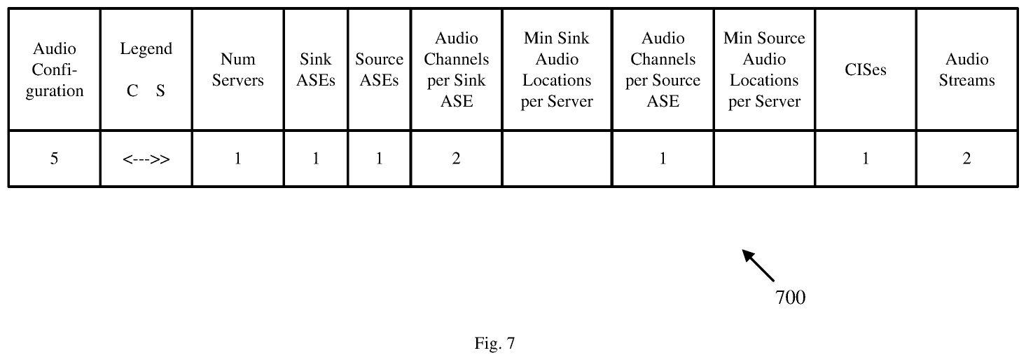

Reference is made to FIG. 7, which schematically illustrates audio configuration characteristics 700, which may be implemented in accordance with some demonstrative aspects.

For example, audio configuration characteristics 700 may be in accordance with the Audio configuration 5 characteristics setting.

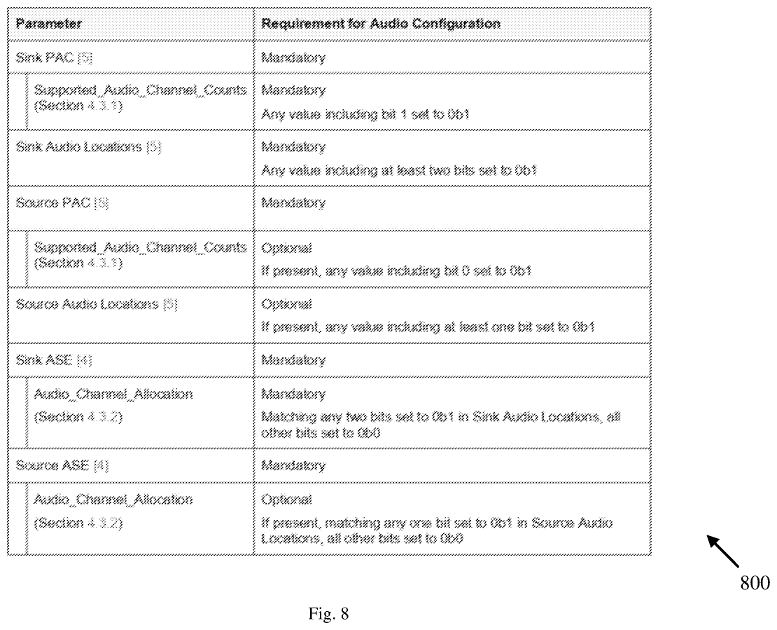

For example, as shown in FIG. 7, audio configuration characteristics 700 may include codec specific capabilities, codec specific configuration, and/or any other requirements for audio configuration, e.g., as shown in FIG. 8.

Reference is made to FIG. 8, which schematically illustrates audio configuration requirements 800, which may be implemented in accordance with some demonstrative aspects.

For example, as shown in FIG. 8, a <<Source ASE>> on a Unicast server may be optional. For example, the <<Source ASE>> may be, e.g., shall be, used as a non-audio content (Head position/rotation) data for spatial audio.

For example, as shown in FIG. 8, the audio configuration characteristics 700 (FIG. 7), may be used with the <<Source ASE>> for spatial audio, for example, with Vendor specific codec specific capabilities, and/or a codec specific configuration, e.g., as described below.

Referring back to FIG. 1, in some demonstrative aspects, device 102 and/or device 140 may be configured to implement a spatial audio streaming mechanism configured to support an ASE configuration mapping between Unicast client and a Unicast server, e.g., as described below.

For example, an ASE configuration mapping between a Unicast client e.g., implemented by device 102, and Unicast Server, e.g., implemented by device 140, may be defined, for example, for non-audio (Spatial audio) content, e.g., as follows:

TABLE 3

| Unicast Client | Unicast Server |
|---|---|
| Accessing handle 0xRRRR (ASE | Handle: 0xRRRR |
| ID, 1), on server for Sink ASE | UUID 0xUUUU = <<Sink ASE>> |
| configurations and enablement | ASE_ID: 1 |
| (left and right speakers) | Streaming (L + R) |
| | LC3, 48 kHz , Music |
| Accessing handle 0xHHHH | Handle: 0xHHHH |
| (ASE_ID: 2) on server for Source | UUID 0xUUUU = <<Source ASE>> |
| ASE configurations and | ASE_ID: 2 |
| enablement (head tracking from | Non-audio content |
| motion sensor) | VS(0xff), Head Rotation/Position |
| | data |

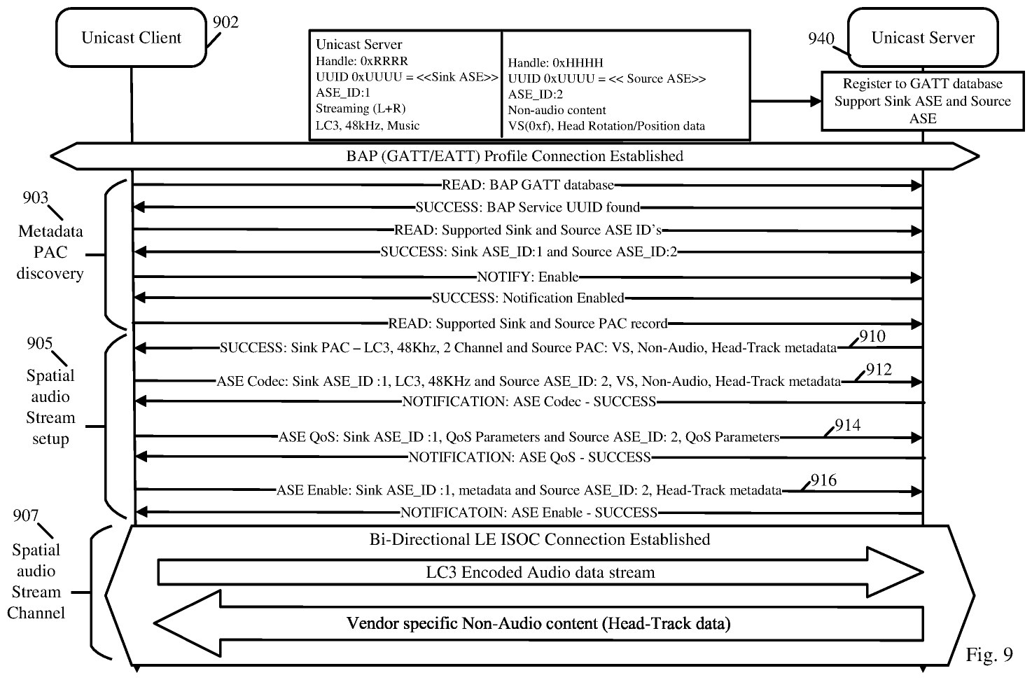

Reference is made to FIG. 9, which schematically illustrates setting up a bidirectional BT stream connection, in accordance with some demonstrative aspects.

For example, the bidirectional BT stream connection may include an LE CIS connection.

In one example, BT device 102 (FIG. 1) may operate as, and/or perform one or more operations and/or functionalities of, a unicast client 902. In one example, BT device 140 (FIG. 1) may operate as, and/or perform one or more operations and/or functionalities of, a unicast server 940.

In some demonstrative aspects, unicast client 902 and unicast server 940 may be configured to perform a bidirectional BT stream connection setup, e.g., as described below.

In some demonstrative aspects, as shown in FIG. 9, unicast client 902 and unicast server 940 may perform a metadata PAC discovery stage 903 of the bidirectional BT stream connection setup, for example, by exchanging one or more stream setup messages.

In some demonstrative aspects, as shown in FIG. 9, unicast client 902 and unicast server 940 may perform a spatial audio steam setup stage 905 of the bidirectional BT stream connection setup, for example, by communicating source capability information in a stream setup message, e.g., in accordance with a PAC protocol.

For example, it may be defined that unicast server 940, e.g., a headset device, may, e.g., shall, register source ASE PACS (also referred to as non-audio (meta data) characteristics), which may, e.g., shall, describe configuration details of a configuration of the non-audio data stream supported by the unicast server 940, for example, a head tracking sensor data format and/or length, a frame duration, and/or an interval, e.g., as described below. For example, the source ASE PACS may describe a Sink ASE, e.g., with standard LC3 audio capabilities and its configurations accordingly.

In some demonstrative aspects, as shown in FIG. 9, unicast server 940 may transmit the stream setup message including a source PAC record message 910.

For example, as shown in FIG. 9, source PAC record message 910 may include vendor specific (VS) non-audio head track metadata, e.g., as described below.

In some demonstrative aspects, the source PAC record message 910 may include a PAC characteristics element, which may include, for example, a metadata parameter representing the source capability information, e.g., as follows:

TABLE 4

| | Size | |
|---|---|---|
| Parameter | (octets) | Description |
| Number_of_PAC_re- | 1 | Number of PAC records, [i], for this |
| cords | | characteristic |
| Codec_ID[i] | 5 | 0xff = Vendor specific |
| | | 0x00 0x02 = Codec Company ID: |
| | | Intel |
| | | 0x00 0x00 = Codec Vendor ID |
| Codec_Specific_Capa- | 1 | 0x07 = Length of the |
| bilities_Length[i] | | Codec_Specific_Configuration |
| | | value for this ASE |
| Codec_Specific_Capa- | Varies | 0x02 0x02 0x13 = Frame Duration: |
| bilities[i] | | 10 ms and 7.5 ms supported, (7.5 ms |
| | | preferred), |
| | | 0x05 0x04 0x00 0x0e 0x00 0x0e = |
| | | Frame Length: min and max 14 bytes |
| | | 0x02 0x05 0x01 = Max supported |
| | | frame length per PDU |
| Metadata_Length[i] | 1 | 0x12 = Length of the Metadata |
| | | parameter for this ASE |
| Metadata[i] | Varies | 0x03 0x01 0x00 0x01: Preferred |
| | | Audio Context LTV (Unspecified |
| | | Audio context) |
| | | 0x0d = Length |
| | | 0xff = Type: Vendor_Specific |
| | | 0x00 0x02 = Company ID: Intel |
| | | 0x02 0x11 0x02 = |
| | | Supported_IMU_Interval Vendor |
| | | specific LTV |
| | | 0x02 0x12 0x0e = |
| | | Supported_Report_Length Vendor |
| | | specific LTV |
| | | 0x03 0x03 0x00 0x7f = |
| | | Selected_Coordinated_system |
| | | Vendor specific LTV |

In one example, a byte sequence of the source PAC record message 910 may be, e.g., shall be, encoded according to Table 4, e.g., as follows:

0xff 0x00 0x02 0x00 0x00 0x07 0x02 0x02 0x13 0x02 0x05 0x01 0x12 0x03 0x01 0x00 0x01 0x0d 0xff 0x00 0x02 0x02 0x11 0x02 0x02 0x12 0x0e 0x03 0x03 0x00 0x7f (1)

For example, the unicast client 902, e.g., an audio source device, may expect to receive the information of Table 4, for example, when requested to unicast server 940 through metadata PAC discovery stage 903.

For example, as shown in Table 4, the metadata parameter may include one or more vendor specific source supported characteristics, which may include, for example, a supported IMU interval, a supported report length, a selected coordinated system, and or any other additional or alternative characteristic.

In some demonstrative aspects, unicast server 940 may, e.g., shall, support a head-orientation data format (a head rotation data format) of the metadata parameter, for example, based on a vendor specific LTV values format description per LTV type, e.g., as follows:

TABLE 5

| | | Type | |
|---|---|---|---|
| Description | Name | (1 octet) | Value |
| Interval of | Sup- | 0x11 | Bitfield (1 octet) |
| head rotation | ported_IMU_In- | | Bit 0: 7.5 ms frame duration. |
| data | terval | | 0b1 = supported, 0b0 = not |
| | | | supported |
| | | | Bit 1: 10 ms frame duration. |
| | | | 0b1 = supported, 0b0 = not |
| | | | supported |
| | | | Bit 2: Reserved for future |
| | | | Use (RFU) |
| | | | Bit 3: RFU |
| | | | Bit 4: 7.5 ms preferred. |
| | | | Valid only when 7.5 ms is |
| | | | supported and 10 ms is |
| | | | supported. Shall not be set |
| | | | to 0b1 if bit 5 is set to 0b1. |
| | | | Bit 5: 10 ms preferred. Valid |
| | | | only when 7.5 ms is |
| | | | supported and 10 ms is |
| | | | supported. Shall not be set |
| | | | to 0b1 if bit 4 is set to 0b1. |
| | | | Bit 6: RFU |
| | | | Bit 7: RFU |
| Head | Supported_Re- | 0x12 | 1 octet = Actual length |
| rotation | port_Length | | value |
| data length | | | |
| Head | Selected_Coordi- | 0x03 | Bitfield (2 Octets) |
| rotation | nated_system | | Bit 0: “Quat-X” 0b1 = |
| data rep- | | | supported, 0b0 = not |
| resentation | | | supported |
| based on Co- | | | Bit 1: “Quat-Y” 0b1 = |
| ordinates | | | supported, 0b0 = not |
| | | | supported |
| | | | Bit 2: “Quat-Z” 0b1 = |
| | | | supported, 0b0 = not |
| | | | supported |
| | | | Bit 3: “Quat-W” 0b1 = |
| | | | supported, 0b0 = not |
| | | | supported |
| | | | Bit 4: “Acc-X” 0b1 = |
| | | | supported, 0b0 = not |
| | | | supported |
| | | | Bit 5: “Acc-Y” 0b1 = |
| | | | supported, 0b0 = not |
| | | | supported |
| | | | Bit 6: “Acc-Z” 0b1 = |
| | | | supported, 0b0 = not |
| | | | supported |

In some demonstrative aspects, it may be defined that an ASE characteristic format, for example, where an “ASE_ID” field, an “ASE_State” field, and/or an “Additional_ASE_Parameters” field for a use case may, e.g., shall, use the relevant fields according to a standard use case, e.g., in accordance with an ASCS Specification.

For example, it may be defined that an ASE control point operation on the format of the Additional_ASE_Parameters field, for example, when ASE_State=0x01 (Codec Configured), 0x02 (QoS Configured), 0x03 (Enabling), 0x04 (Streaming), or (Disabling) may, e.g., shall, follow the same ASE state machine.

In some demonstrative aspects, it may be defined that the ASE characteristic format may, e.g., shall, be preconfigured, for example, in accordance with the ASCS Specification, e.g., as follows:

TABLE 6

| | Size | |
|---|---|---|
| Field | (Octets) | Description |
| ASE_ID | 1 | Identifier of this ASE, assigned by the |
| | | server. A different ASE_ID namespace |
| | | exists for each connected client. Each |
| | | ASE_ID in a namespace shall be |
| | | unique. Shall not change for a client if |
| | | the server has a trusted relationship |
| | | with that client. Shall not be assigned a |
| | | value of 0x00 by the server. |
| ASE_State | 1 | State of the ASE with respect to the |
| | | ASE state machine Value: 0x00-0x06 |
| | | (see Table 3.1) All other values: RFU |
| Additional_ASE_Pa- | Varies | Dependent on states defined in Table |
| rameters | | 3.1 Idle state or Releasing state: Empty |
| | | (zero length) States in Table 3.1 other |
| | | than the Idle state or the Releasing |
| | | state: see Table 4.3, Table 4.4, or Table |
| | | 4.5 All other values: RFU |

In some demonstrative aspects, as shown in FIG. 9, unicast client 902 may transmit to unicast server 940 an additional ASE parameter field in an ASE codec message 912. For example, ASE codec message 912 may include an ASE ID for the non-audio data stream, a codec specific configuration length field to indicate a frame length for the non-audio data stream, and/or a codec specific configuration field to indicate a frame duration for the non-audio data stream, a number of octets per frame for the non-audio data stream, and/or a maximal supported frame length per Protocol Data Unit (PDU) for the non-audio data stream, e.g., as described below.

For example, as shown in FIG. 9, ASE codec message 912 may include VS non-audio head-track metadata.

For example, it may be defined that an ASE that may be, e.g., shall be, capable of handling the non-audio content, may include the additional ASE parameter field (“Additional_ASE_parameters”), for example, based on an ASE_State of the ASE.

For example, it may be defined that one or more parameters in the additional ASE parameter field may be configured, e.g., in accordance with an ASCS profile/protocol.

In some demonstrative aspects, for example, in order to adopt establishing of a CIS stream connection through which non-audio head-orientation data (head rotation data) may be, e.g., shall be, transferred, it may be defined that one or more parameters, e.g., newly-defined parameters, may be included in the additional ASE parameter field, e.g., in accordance with the ASCS profile/protocol.

In some demonstrative aspects, a format of the additional ASE parameter field (the Additional_ASE_Parameters fields), for example, when ASE_State=0x01 (Codec Configured) may be defined, e.g., as follows:

TABLE 7

| | Size | |
|---|---|---|
| | (Octets) | Description |
| Opcode | | |
| 0x01 | 1 | 0x01 = Config Codec |
| Parameter | | |
| Number_of_ASEs | 1 | Total number of ASEs used in |
| | | the Config Codec |
| | | operation |
| | | Shall be ≥1 |
| ASE_ID[i] | 1 | ASE_ID for this ASE |
| Target_Latency[i] | 1 | 0x01 = Target low latency |
| Target_PHY[i] | 1 | 0x02 = LE 2M PHY |
| Codec_ID[i] | 5 | 0xff = Vendor specific |
| | | 0x00 0x02 = Codec Company |
| | | ID: Intel |
| | | 0x00 0x00 = Codec Vendor ID |
| Codec_Specific_Config- | 1 | 0x0a = Length of the |
| uration_Length [i] | | Codec_Specific_Configuration |
| | | value for this ASE |
| Codec_Specific_Config- | Varies | 0x02 0x02 0x01 = Frame |
| uration[i] | | Duration: 10 ms |
| | | 0x03 0x04 0x00 0x0e = Octets |
| | | per frame: 14 bytes 0x02 0x05 |
| | | 0x01 = Max supported frame |
| | | length per PDU |

In some demonstrative aspects, as shown in FIG. 9, unicast client 902 may transmit an additional ASE parameter field in an ASE QoS message 914 to unicast server 940. For example, it may be defined that the additional ASE parameter field is to include an ASE ID for the non-audio data stream, a maximal SDU field to indicate an SDU length for the non-audio data stream, a retransmission number field to indicate a zero retransmission policy for the non-audio data stream, and/or a maximal transport latency field to indicate a maximal latency for the non-audio data stream.

For example, as shown in FIG. 9, ASE QoS message 914 may include one or more QoS parameters.

In some demonstrative aspects, a format of the additional ASE parameter field (the Additional_ASE_Parameters field), for example, when ASE_State=0x02 (QoS Configured) may be defined, e.g., as follows:

TABLE 8

| | Size | |
|---|---|---|
| | (Octets) | Description |
| Opcode | | |
| 0x02 | 1 | 0x02 = Config QoS |
| Parameter | | |
| Number_of_ASEs | 1 | Total number of ASEs used |
| | | in the Config Codec |
| | | operation |
| | | Shall be ≥1 |
| ASE_ID[i] | 1 | ASE_ID for this ASE |
| CIG_ID[i] | 1 | CIG_ID parameter value written |
| | | by the client for this ASE |
| CIS_ID[i] | 1 | CIS_ID parameter value written |
| | | by the client for this ASE |
| SDU_Interval[i] | 3 | 10000 usec |
| Framing[i] | 1 | 0x00 = Unframed |
| PHY[i] | 1 | 0x02 = LE 2M PHY |
| Max_SDU[i] | 2 | 0x00 0x0e = 14 Bytes |
| Retransmission_Number[i] | 1 | 0x00 |
| Max_Transport_Latency[i] | 2 | 10 ms |
| Presentation_Delay[i] | 3 | 0 us |

In some demonstrative aspects, as shown in FIG. 9, unicast client 902 may transmit a stream setup enable message to unicast client 902. For example, the stream setup enable message may include non-audio data stream configuration information to indicate the configuration of the non-audio data stream.

In some demonstrative aspects, the non-audio data stream configuration information may include an enabled interval between data frames of the non-audio data stream, an enabled length of a data frame of the non-audio data stream, and/or an enabled coordinate system for the head-orientation data.

In some demonstrative aspects, as shown in FIG. 9, unicast client 902 may transmit an ASE enable message 916 to unicast client 902. For example, ASE enable message 916 may be configured to indicate the non-audio data stream configuration information in a metadata parameter, for example, in an additional ASE parameter field of the ASE enable message 916.

In some demonstrative aspects, a format of the additional ASE parameter field (the Additional_ASE_Parameters field) in the ASE enable message 916, for example, when ASE_State=0x03 (Enabling), may be defined, e.g., as follows:

TABLE 9

| | Size | |
|---|---|---|
| | (Octets) | Description |
| Opcode | | |
| 0x03 | 1 | 0x03 = Enabling |
| Parameter | | |
| Number_of_ASEs | 1 | Total number of ASEs used in the |
| | | Config Codec operation |
| | | Shall be ≥1 |
| ASE_ID[i] | 1 | ASE_ID for this ASE |
| Metadata_Length[i] | 1 | 0x0d = Length of the Metadata parameter |
| | | for this ASE |
| Metadata[i] | Varies | 0xff = Type: Vendor_Specific |
| | | 0x00 0x02 = Company ID: Intel |
| | | 0x02 0x01 0x02 = Supported_IMU_In- |
| | | terval Vendor specific LTV |
| | | 0x02 0x02 0x0e = Supported_Re- |
| | | port_Length Vendor specific LTV |
| | | 0x03 0x03 0x00 0x7f = |
| | | Selected_Coordinated_system Vendor |
| | | specific LTV |

In some demonstrative aspects, the additional ASE parameter field in the ASE enable message 916 may support a vendor specific LTV values format per LTV Type, which may be configured, e.g., as follows:

TABLE 10

| | Type | |
|---|---|---|
| Name | (1 octet) | Value |
| Supported_IMU_In- | 0x01 | Bitfield (1 octet) |
| terval | | Bit 0: 7.5 ms frame duration. 0b1 = |
| | | supported, 0b0 = not supported |
| | | Bit 1: 10 ms frame duration. 0b1 = |
| | | supported, 0b0 = not supported |
| | | Bit 2: RFU |
| | | Bit 3: RFU |
| | | Bit 4: 7.5 ms preferred. Valid only |
| | | when 7.5 ms is supported and 10 ms is |
| | | supported. Shall not be set to 0b1 if bit |
| | | 5 is set to 0b1. |
| | | Bit 5: 10 ms preferred. Valid only when |
| | | 7.5 ms is supported and 10 ms is |
| | | supported. Shall not be set to 0b1 if bit |
| | | 4 is set to 0b1. |
| | | Bit 6: RFU |
| | | Bit 7: RFU |
| Supported_Re- | 0x02 | 1 octet = Actual length value |
| port_Length | | |
| Selected_Coordi- | 0x03 | Bitfield (2 Octets) |
| nated_system | | Bit 0: “Quat-X” 0b1 = supported, |
| | | 0b0 = not supported |
| | | Bit 1: “Quat-Y” 0b1 = supported, |
| | | 0b0 = not supported |
| | | Bit 2: “Quat-Z” 0b1 = supported, |
| | | 0b0 = not supported |
| | | Bit 3: “Quat-W” 0b1 = supported, |
| | | 0b0 = not supported |
| | | Bit 4: “Acc-X” 0b1 = supported, |
| | | 0b0 = not supported |
| | | Bit 5: “Acc-Y” Ob1 = supported, |
| | | 0b0 = not supported |
| | | Bit 6: “Acc-Z” 0b1 = supported, |
| | | 0b0 = not supported |

In some demonstrative aspects, as shown in FIG. 9, unicast server 940 may initiate communication over the bidirectional BT stream connection, for example, based on an ASE receiver start message from unicast client 902.

In some demonstrative aspects, an additional ASE parameter field of the ASE receiver start message may include a first ASE ID to identify an ASE for the audio data stream, and a second ASE ID to identify an ASE for the non-audio data stream.

In some demonstrative aspects, a format of the additional ASE parameter field (the Additional_ASE_Parameters field) of the ASE receiver start message, for example, when ASE_State=0x04 (Receiver Start Ready) or ASE_State=0x05 (Disable), may be defined, e.g., as follows:

TABLE 11

| | Size | |
|---|---|---|
| | (Octets) | Description |
| Opcode | | |
| 0x04/0x05 | 1 | 0x04 = Receiver Start Ready or |
| | | 0x05 = Disable |
| Parameter | | |
| Number_of_ASEs | 1 | Total number of ASEs used in the |
| | | Config Codec operation |
| | | Shall be ≥1 |
| ASE_ID[i] | 1 | ASE_ID for this ASE |

For example, the additional ASE parameter field of the ASE receiver start message may include two ASE IDs, for example, when the Number of ASEs field shown in Table 11 is set to two.

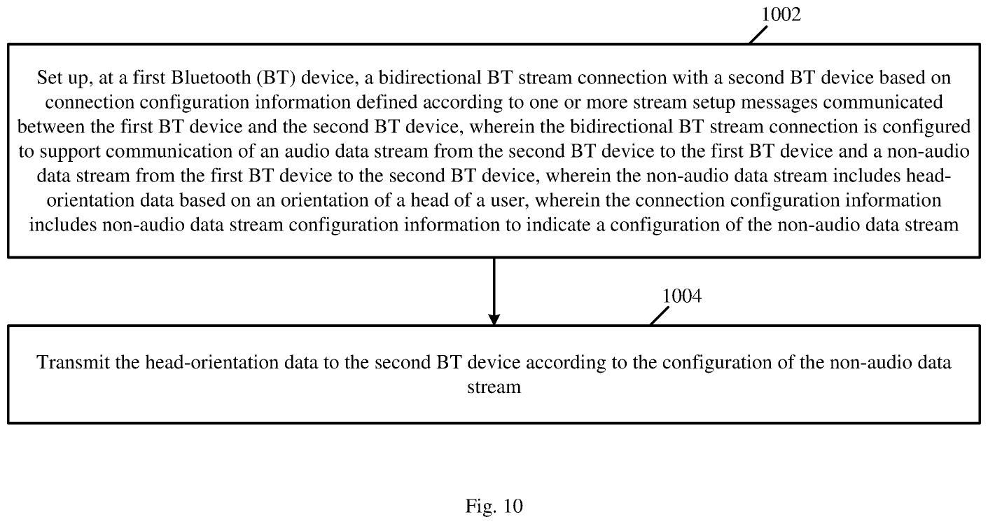

Reference is made to FIG. 10, which schematically illustrates a method of communicating audio data and non-audio data over a bidirectional BT stream connection, in accordance with some demonstrative aspects. For example, one or more of the operations of the method of FIG. 10 may be performed by one or more elements of a system, e.g., system 100 (FIG. 1), for example, one or more BT devices, e.g., BT device 102 (FIG. 1), and/or BT device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 1002, the method may include setting up at a first BT device a bidirectional BT stream connection with a second BT device, for example, based on connection configuration information defined according to one or more stream setup messages communicated between the first BT device and the second BT device. For example, the bidirectional BT stream connection may be configured to support communication of an audio data stream from the second BT device to the first BT device and a non-audio data stream from the first BT device to the second BT device. For example, the non-audio data stream may include head-orientation data based on an orientation of a head of a user. For example, the connection configuration information may include non-audio data stream configuration information to indicate a configuration of the non-audio data stream. For example, controller 154 (FIG. 1) may be configured to cause, trigger, and/or control BT device 140 (FIG. 1) to set up a bidirectional BT stream connection with BT device 102 (FIG. 1), for example, based on connection configuration information defined according to one or more stream setup messages communicated between BT device 140 (FIG. 1) and BT device 102 (FIG. 1), e.g., as described above.

As indicated at block 1004, the method may include transmitting the head-orientation data to the second BT device according to the configuration of the non-audio data stream. For example, controller 154 (FIG. 1) may be configured to cause, trigger, and/or control BT device 140 (FIG. 1) to transmit the head-orientation data to BT device 102 (FIG. 1) according to the configuration of the non-audio data stream, e.g., as described above.

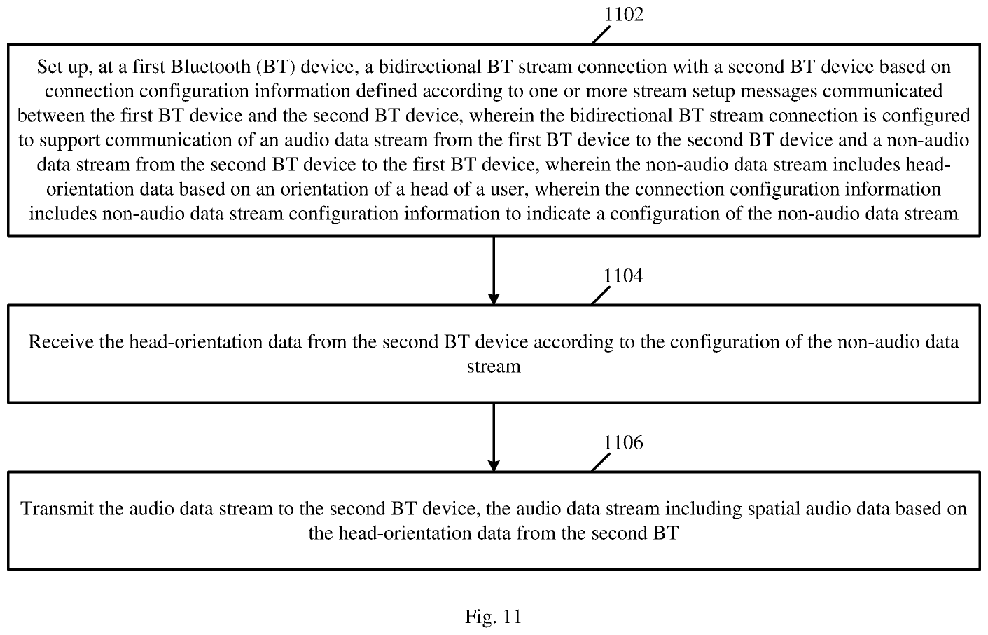

Reference is made to FIG. 11, which schematically illustrates a method of communicating audio data and non-audio data over a bidirectional BT stream connection, in accordance with some demonstrative aspects. For example, one or more of the operations of the method of FIG. 11 may be performed by one or more elements of a system, e.g., system 100 (FIG. 1), for example, one or more BT devices, e.g., BT device 102 (FIG. 1), and/or BT device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 1102, the method may include setting up at a first BT device a bidirectional BT stream connection with a second BT device based on connection configuration information defined according to one or more stream setup messages communicated between the first BT device and the second BT device. For example, the bidirectional BT stream connection may be configured to support communication of an audio data stream from the first BT device to the second BT device, and a non-audio data stream from the second BT device to the first BT device. For example, the non-audio data stream may include head-orientation data based on an orientation of a head of a user. For example, the connection configuration information may include non-audio data stream configuration information to indicate a configuration of the non-audio data stream. For example, controller 124 (FIG. 1) may be configured to cause, trigger, and/or control BT device 102 (FIG. 1) to set up a bidirectional BT stream connection with BT device 140 (FIG. 1) based on connection configuration information defined according to one or more stream setup messages communicated between BT device 102 (FIG. 1) and BT device 140 (FIG. 1), e.g., as described above.

As indicated at block 1104, the method may include receiving the head-orientation data from the second BT device according to the configuration of the non-audio data stream. For example, controller 124 (FIG. 1) may be configured to cause, trigger, and/or control BT device 102 (FIG. 1) to receive the head-orientation data from BT device 140 (FIG. 1) according to the configuration of the non-audio data stream, e.g., as described above.

As indicated at block 1106, the method may include transmitting the audio data stream to the second BT device. For example, the audio data stream may include spatial audio data based on the head-orientation data from the second BT. For example, controller 124 (FIG. 1) may be configured to cause, trigger, and/or control BT device 102 (FIG. 1) to transmit to BT device 140 (FIG. 1) the audio data stream including spatial audio data based on the head-orientation data from BT device 140 (FIG. 1), e.g., as described above.

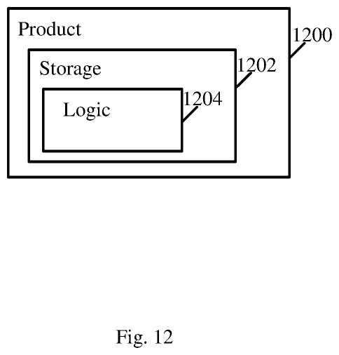

Reference is made to FIG. 12, which schematically illustrates a product of manufacture 1200, in accordance with some demonstrative aspects. Product 1200 may include one or more tangible computer-readable (“machine-readable”) non-transitory storage media 1202, which may include computer-executable instructions, e.g., implemented by logic 1204, operable to, when executed by at least one computer processor, enable the at least one computer processor to implement one or more operations at device 102 (FIG. 1), device 140 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, 7, 8, 9, 10, and/or 11, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1200 and/or machine readable storage media 1202 may include one or more types of computer-readable storage media capable of storing data, including volatile memory, non-volatile memory, removable or non-removable memory, erasable or non-erasable memory, writeable or re-writeable memory, and the like. For example, machine readable storage media 1202 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1204 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1204 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a first Bluetooth (BT) device to set up a bidirectional BT stream connection with a second BT device based on connection configuration information defined according to one or more stream setup messages communicated between the first BT device and the second BT device, wherein the bidirectional BT stream connection is configured to support communication of an audio data stream from the second BT device to the first BT device and a non-audio data stream from the first BT device to the second BT device, wherein the non-audio data stream comprises head-orientation data based on an orientation of a head of a user, wherein the connection configuration information comprises non-audio data stream configuration information to indicate a configuration of the non-audio data stream; and transmit the head-orientation data to the second BT device according to the configuration of the non-audio data stream.

Example 2 includes the subject matter of Example 1, and optionally, wherein the apparatus is configured to cause the first BT device to set source capability information in a stream setup message to be transmitted from the first BT device to the second BT device, wherein the source capability information comprises one or more source supported characteristics, which are supported by the first BT device for the non-audio data stream.

Example 3 includes the subject matter of Example 2, and optionally, wherein the one or more source supported characteristics comprises at least one of a source supported interval between data frames of the non-audio data stream, a source supported report length of a data frame of the non-audio data stream, or a source supported coordinate system for the head-orientation data.

Example 4 includes the subject matter of Example 2 or 3, configured to cause the first BT device to set a metadata parameter to represent the source capability information, wherein the stream setup message comprises a source Published Audio Capabilities (PAC) record message comprising a source PAC characteristics element, wherein the source PAC characteristics element comprises the metadata parameter.

Example 5 includes the subject matter of any one of Examples 1-4, and optionally, wherein the apparatus is configured to cause the first BT device to process a stream setup enable message from the second BT device to identify the non-audio data stream configuration information to indicate the configuration of the non-audio data stream.

Example 6 includes the subject matter of Example 5, and optionally, wherein the non-audio data stream configuration information comprises at least one of an enabled interval between data frames of the non-audio data stream, an enabled length of a data frame of the non-audio data stream, or an enabled coordinate system for the head-orientation data.

Example 7 includes the subject matter of Example 5 or 6, and optionally, wherein the apparatus is configured to cause the first BT device to process an Audio Stream Endpoint (ASE) enable message from the second BT device to identify the non-audio data stream configuration information in a metadata parameter in an additional ASE parameter field of the ASE enable message.

Example 8 includes the subject matter of any one of Examples 1-7, and optionally, wherein the apparatus is configured to cause the first BT device to process an additional Audio Stream Endpoint (ASE) parameter field in an ASE codec message from the second BT device to identify an ASE Identifier (ID) for the non-audio data stream, a codec specific configuration length field to indicate a frame length for the non-audio data stream, and a codec specific configuration field to indicate a frame duration for the non-audio data stream, a number of octets per frame for the non-audio data stream, and a maximal supported frame length per Protocol Data Unit (PDU) for the non-audio data stream.

Example 9 includes the subject matter of any one of Examples 1-8, and optionally, wherein the apparatus is configured to cause the first BT device to process an additional Audio Stream Endpoint (ASE) parameter field in an ASE Quality of Service (QoS) message from the second BT device to identify an ASE Identifier (ID) for the non-audio data stream, a maximal Stream Data Unit (SDU) field to indicate an SDU length for the non-audio data stream, a retransmission number field to indicate a zero retransmission policy for the non-audio data stream, and a maximal transport latency field to indicate a maximal latency for the non-audio data stream.

Example 10 includes the subject matter of any one of Examples 1-9, and optionally, wherein the apparatus is configured to cause the first BT device to transmit the head-orientation data in Stream Data Units (SDUs) configured according to the non-audio data stream configuration information.

Example 11 includes the subject matter of Example 10, and optionally, wherein an SDU size of an SDU is no more than 14 bytes.

Example 12 includes the subject matter of any one of Examples 1-11, and optionally, wherein the apparatus is configured to cause the first BT device to initiate communication over the bidirectional BT stream connection based on an Audio Stream Endpoint (ASE) receiver start message from the second BT device, wherein an additional ASE parameter field of the ASE receiver start message comprises a first ASE Identifier (ID) to identify an ASE for the audio data stream, and a second ASE_ID to identify an ASE for the non-audio data stream.

Example 13 includes the subject matter of any one of Examples 1-12, and optionally, wherein the head-orientation data comprises at least one of angle of rotation information representing an angle of rotation of the head of the user, or acceleration information representing an acceleration of the head of the user.

Example 14 includes the subject matter of any one of Examples 1-13, and optionally, wherein the head-orientation data comprises angle of rotation information representing an angle of rotation of the head of the user in a quaternion format.

Example 15 includes the subject matter of any one of Examples 1-14, and optionally, wherein the head-orientation data comprises body-based movement data, which is based on a body movement of the user.

Example 16 includes the subject matter of any one of Examples 1-15, and optionally, wherein the head-orientation data comprises head-based movement data, which is based on a head movement of the user.

Example 17 includes the subject matter of any one of Examples 1-16, and optionally, wherein the head-orientation data is based on orientation information from a headphone device to provide audio to the user based on the audio data stream.

Example 18 includes the subject matter of any one of Examples 1-17, and optionally, wherein the head-orientation data is based on orientation information from at least one ear piece to provide audio to the user based on the audio data stream.

Example 19 includes the subject matter of any one of Examples 1-18, and optionally, wherein the non-audio data stream configuration information is to configure the non-audio data stream with a latency of no more than 10 milliseconds.

Example 20 includes the subject matter of any one of Examples 1-19, and optionally, wherein the non-audio data stream configuration information is to configure the non-audio data stream according to a zero retransmission policy defining no retransmission of the head-orientation data.

Example 21 includes the subject matter of any one of Examples 1-20, and optionally, wherein the apparatus is configured to cause the first BT device to setup a sink Audio Stream Endpoint (ASE) at the first BT device to receive the audio data stream from the second BT device, and a source ASE at the first BT device to transmit the non-audio data stream to the second BT device.

Example 22 includes the subject matter of any one of Examples 1-21, and optionally, wherein the apparatus is configured to cause the first BT device to setup the bidirectional BT stream connection as a bidirectional Low Energy (LE) Connected Isochronous Stream (CIS) connection.

Example 23 includes the subject matter of any one of Examples 1-22, and optionally, wherein the audio data stream comprises two audio channels comprising spatial audio data to be provided to a headphone device.

Example 24 includes the subject matter of any one of Examples 1-23, and optionally, comprising at least one radio to transmit the head-orientation data to the second BT device.

Example 25 includes the subject matter of Example 24, and optionally, comprising one or more antennas connected to the radio, and a processor to execute instructions of an operating system.

Example 26 includes an apparatus comprising logic and circuitry configured to cause a first Bluetooth (BT) device to set up a bidirectional BT stream connection with a second BT device based on connection configuration information defined according to one or more stream setup messages communicated between the first BT device and the second BT device, wherein the bidirectional BT stream connection is configured to support communication of an audio data stream from the first BT device to the second BT device and a non-audio data stream from the second BT device to the first BT device, wherein the non-audio data stream comprises head-orientation data based on an orientation of a head of a user, wherein the connection configuration information comprises non-audio data stream configuration information to indicate a configuration of the non-audio data stream; receive the head-orientation data from the second BT device according to the configuration of the non-audio data stream; and transmit the audio data stream to the second BT device, the audio data stream comprising spatial audio data based on the head-orientation data from the second BT.

Example 27 includes the subject matter of Example 26, and optionally, wherein the apparatus is configured to cause the first BT device to process source capability information in a stream setup message from the second BT device, wherein the source capability information comprises one or more source supported characteristics, which are supported by the second BT device for the non-audio data stream.

Example 28 includes the subject matter of Example 27, and optionally, wherein the one or more source supported characteristics comprises at least one of a source supported interval between data frames of the non-audio data stream, a source supported report length of a data frame of the non-audio data stream, or a source supported coordinate system for the head-orientation data.

Example 29 includes the subject matter of Example 27 or 28, and optionally, wherein the stream setup message comprises a source Published Audio Capabilities (PAC) record message comprising a source PAC characteristics element, wherein the source PAC characteristics element comprises a metadata parameter to represent the source capability information.

Example 30 includes the subject matter of any one of Examples 26-29, and optionally, wherein the apparatus is configured to cause the first BT device to transmit a stream setup enable message to the second BT, the stream setup enable message comprising the non-audio data stream configuration information to indicate the configuration of the non-audio data stream.

Example 31 includes the subject matter of Example 30, and optionally, wherein the non-audio data stream configuration information comprises at least one of an enabled interval between data frames of the non-audio data stream, an enabled length of a data frame of the non-audio data stream, or an enabled coordinate system for the head-orientation data.

Example 32 includes the subject matter of Example 30-31, and optionally, wherein the apparatus is configured to cause the first BT device to transmit an Audio Stream Endpoint (ASE) enable message to the second BT device, the ASE enable message comprising the non-audio data stream configuration information in a metadata parameter in an additional ASE parameter field of the ASE enable message.

Example 33 includes the subject matter of any one of Examples 26-32, and optionally, wherein the apparatus is configured to cause the first BT device to set an additional Audio Stream Endpoint (ASE) parameter field in an ASE codec message to the second BT device, the additional ASE parameter field comprising an ASE Identifier (ID) for the non-audio data stream, a codec specific configuration length field to indicate a frame length for the non-audio data stream, and a codec specific configuration field to indicate a frame duration for the non-audio data stream, a number of octets per frame for the non-audio data stream, and a maximal supported frame length per Protocol Data Unit (PDU) for the non-audio data stream.

Example 34 includes the subject matter of Example 33, and optionally, wherein the apparatus is configured to cause the first BT device to set the codec specific configuration field to set the frame duration for the non-audio data stream to 1 milliseconds, and to set the number of octets per frame for the non-audio data stream to 14 octets.

Example 35 includes the subject matter of any one of Examples 26-35, and optionally, wherein the apparatus is configured to cause the first BT device to set an additional Audio Stream Endpoint (ASE) parameter field in an ASE Quality of Service (QoS) message to the second BT device, the additional ASE parameter field comprising an ASE Identifier (ID) for the non-audio data stream, a maximal Stream Data Unit (SDU) field to indicate an SDU length for the non-audio data stream, a retransmission number field to indicate a zero retransmission policy for the non-audio data stream, and a maximal transport latency field to indicate a maximal latency for the non-audio data stream.

Example 36 includes the subject matter of Example 35, and optionally, wherein the apparatus is configured to cause the first BT device to set the maximal SDU field to indicate a length of 14 bytes, and to set the maximal transport latency field to indicate a maximal latency of 10 milliseconds.

Example 37 includes the subject matter of any one of Examples 26-36, and optionally, wherein the apparatus is configured to cause the first BT device to process the head-orientation data received from the second BT device in Stream Data Units (SDUs) configured according to the non-audio data stream configuration information.

Example 38 includes the subject matter of Example 37, and optionally, wherein an SDU size of an SDU is no more than 14 bytes.

Example 39 includes the subject matter of any one of Examples 26-38, and optionally, wherein the apparatus is configured to cause the first BT device to transmit an Audio Stream Endpoint (ASE) receiver start message to the second BT device to initiate communication over the bidirectional BT stream connection, wherein an additional ASE parameter field of the ASE receiver start message comprises a first ASE Identifier (ID) to identify an ASE for the audio data stream, and a second ASE_ID to identify an ASE for the non-audio data stream.

Example 40 includes the subject matter of any one of Examples 26-39, and optionally, wherein the head-orientation data comprises at least one of angle of rotation information representing an angle of rotation of the head of the user, or acceleration information representing an acceleration of the head of the user.

Example 41 includes the subject matter of any one of Examples 26-40, and optionally, wherein the head-orientation data comprises angle of rotation information representing an angle of rotation of the head of the user in a quaternion format.

Example 42 includes the subject matter of any one of Examples 26-41, and optionally, wherein the head-orientation data comprises body-based movement data, which is based on a body movement of the user.

Example 43 includes the subject matter of any one of Examples 26-42, and optionally, wherein the head-orientation data comprises head-based movement data, which is based on a head movement of the user.

Example 44 includes the subject matter of any one of Examples 26-43, and optionally, wherein the head-orientation data is based on orientation information from a headphone device to provide audio to the user based on the audio data stream.

Example 45 includes the subject matter of any one of Examples 26-44, and optionally, wherein the head-orientation data is based on orientation information from at least one ear piece to provide audio to the user based on the audio data stream.

Example 46 includes the subject matter of any one of Examples 26-45, and optionally, wherein the non-audio data stream configuration information is to configure the non-audio data stream with a latency of no more than 10 milliseconds.

Example 47 includes the subject matter of any one of Examples 26-46, and optionally, wherein the non-audio data stream configuration information is to configure the non-audio data stream according to a zero retransmission policy defining no retransmission of the head-orientation data.

Example 48 includes the subject matter of any one of Examples 26-47, and optionally, wherein the apparatus is configured to cause the first BT device to setup the bidirectional BT stream connection as a bidirectional Low Energy (LE) Connected Isochronous Stream (CIS) connection.

Example 49 includes the subject matter of any one of Examples 26-48, and optionally, wherein the audio data stream comprises two audio channels comprising spatial audio data to be provided to a headphone device.

Example 50 includes the subject matter of any one of Examples 26-49, and optionally, comprising at least one radio to transmit the audio data to the second BT device.

Example 51 includes the subject matter of Example 50, and optionally, comprising one or more antennas connected to the radio, and a processor to execute instructions of an operating system.

Example 52 comprises a wireless communication device comprising the apparatus of any of Examples 1-51.

Example 53 comprises a mobile device comprising the apparatus of any of Examples 1-51.

Example 54 comprises an apparatus comprising means for executing any of the described operations of any of Examples 1-51.

Example 55 comprises a product comprising one or more tangible computer-readable non-transitory storage media comprising instructions operable to, when executed by at least one processor, enable the at least one processor to cause a wireless communication device to perform any of the described operations of any of Examples 1-51.

Example 56 comprises an apparatus comprising: a memory interface; and processing circuitry configured to: perform any of the described operations of any of Examples 1-51.

Example 57 comprises a method comprising any of the described operations of any of Examples 1-51.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a first Bluetooth (BT) device to:
set up a bidirectional BT stream connection with a second BT device based on connection configuration information defined according to one or more stream setup messages communicated between the first BT device and the second BT device, wherein the bidirectional BT stream connection is configured to support communication of an audio data stream from the second BT device to the first BT device and a non-audio data stream from the first BT device to the second BT device, wherein the non-audio data stream comprises head-orientation data based on an orientation of a head of a user, wherein the connection configuration information comprises non-audio data stream configuration information to indicate a configuration of the non-audio data stream; and
transmit the head-orientation data to the second BT device according to the configuration of the non-audio data stream.

2. The apparatus of claim 1 configured to cause the first BT device to set source capability information in a stream setup message to be transmitted from the first BT device to the second BT device, wherein the source capability information comprises one or more source supported characteristics, which are supported by the first BT device for the non-audio data stream.

3. The apparatus of claim 2, wherein the one or more source supported characteristics comprises at least one of a source supported interval between data frames of the non-audio data stream, a source supported report length of a data frame of the non-audio data stream, or a source supported coordinate system for the head-orientation data.

4. The apparatus of claim 2, configured to cause the first BT device to set a metadata parameter to represent the source capability information, wherein the stream setup message comprises a source Published Audio Capabilities (PAC) record message comprising a source PAC characteristics element, wherein the source PAC characteristics element comprises the metadata parameter.

5. The apparatus of claim 1 configured to cause the first BT device to process a stream setup enable message from the second BT device to identify the non-audio data stream configuration information to indicate the configuration of the non-audio data stream.

6. The apparatus of claim 5, wherein the non-audio data stream configuration information comprises at least one of an enabled interval between data frames of the non-audio data stream, an enabled length of a data frame of the non-audio data stream, or an enabled coordinate system for the head-orientation data.

7. The apparatus of claim 5 configured to cause the first BT device to process an Audio Stream Endpoint (ASE) enable message from the second BT device to identify the non-audio data stream configuration information in a metadata parameter in an additional ASE parameter field of the ASE enable message.

8. The apparatus of claim 1 configured to cause the first BT device to process an additional Audio Stream Endpoint (ASE) parameter field in an ASE codec message from the second BT device to identify an ASE Identifier (ID) for the non-audio data stream, a codec specific configuration length field to indicate a frame length for the non-audio data stream, and a codec specific configuration field to indicate a frame duration for the non-audio data stream, a number of octets per frame for the non-audio data stream, and a maximal supported frame length per Protocol Data Unit (PDU) for the non-audio data stream.

9. The apparatus of claim 1 configured to cause the first BT device to process an additional Audio Stream Endpoint (ASE) parameter field in an ASE Quality of Service (QoS) message from the second BT device to identify an ASE Identifier (ID) for the non-audio data stream, a maximal Stream Data Unit (SDU) field to indicate an SDU length for the non-audio data stream, a retransmission number field to indicate a zero retransmission policy for the non-audio data stream, and a maximal transport latency field to indicate a maximal latency for the non-audio data stream.

10. The apparatus of claim 1 configured to cause the first BT device to initiate communication over the bidirectional BT stream connection based on an Audio Stream Endpoint (ASE) receiver start message from the second BT device, wherein an additional ASE parameter field of the ASE receiver start message comprises a first ASE Identifier (ID) to identify an ASE for the audio data stream, and a second ASE_ID to identify an ASE for the non-audio data stream.

11. The apparatus of claim 1, wherein the head-orientation data comprises at least one of angle of rotation information representing an angle of rotation of the head of the user, or acceleration information representing an acceleration of the head of the user.

12. The apparatus of claim 1, wherein the head-orientation data comprises body-based movement data, which is based on a body movement of the user.

13. The apparatus of claim 1, wherein the head-orientation data comprises head-based movement data, which is based on a head movement of the user.

14. The apparatus of claim 1, wherein the non-audio data stream configuration information is to configure the non-audio data stream according to a zero retransmission policy defining no retransmission of the head-orientation data.

15. The apparatus of claim 1 configured to cause the first BT device to setup the bidirectional BT stream connection as a bidirectional Low Energy (LE) Connected Isochronous Stream (CIS) connection.

16. The apparatus of claim 1, wherein the audio data stream comprises two audio channels comprising spatial audio data to be provided to a headphone device.

17. The apparatus of claim 1 comprising at least one radio to transmit the head-orientation data to the second BT device.

18. The apparatus of claim 17 comprising one or more antennas connected to the radio, and a processor to execute instructions of an operating system.

19. A product comprising one or more tangible computer-readable non-transitory storage media comprising instructions operable to, when executed by at least one processor, enable the at least one processor to cause a first Bluetooth (BT) device to:
set up a bidirectional BT stream connection with a second BT device based on connection configuration information defined according to one or more stream setup messages communicated between the first BT device and the second BT device, wherein the bidirectional BT stream connection is configured to support communication of an audio data stream from the second BT device to the first BT device and a non-audio data stream from the first BT device to the second BT device, wherein the non-audio data stream comprises head-orientation data based on an orientation of a head of a user, wherein the connection configuration information comprises non-audio data stream configuration information to indicate a configuration of the non-audio data stream; and
transmit the head-orientation data to the second BT device according to the configuration of the non-audio data stream.

20. The product of claim 19, wherein the head-orientation data comprises at least one of angle of rotation information representing an angle of rotation of the head of the user, or acceleration information representing an acceleration of the head of the user.
